(19) United States
(12) Patent Application Publication
(10) Pub. No.: US 2025/0064079 A1
(43) Pub. Date: Feb. 27, 2025

(54) EXTRUSION ASSEMBLY FOR A MICRO PUREE MACHINE

(71) Applicant: SharkNinja Operating LLC, Needham, MA (US)

(72) Inventors: Jonathan James, Witney (GB); Nathan Lyell, Suffolk (GB); Jared Proulx, Northborough, MA (US); Andrew David Zdeblick, Reading, MA (US)

(73) Assignee: SharkNinja Operating LLC, Needham, MA (US)

(21) Appl. No.: 18/606,874

(22) Filed: Mar. 15, 2024

Related U.S. Application Data
(63) Continuation-in-part of application No. 18/531,807, filed on Dec. 7, 2023.
(60) Provisional application No. 63/578,744, filed on Aug. 25, 2023.

(51) Int. Cl. A23G 9/22; A23G 9/12; A47J 43/044; A47J 43/07; A47J 43/08

(52) U.S. Cl. CPC A23G 9/224; A23G 9/12; A23G 9/228; A47J 43/044; A47J 43/0711; A47J 43/082

(57) ABSTRACT

An extrusion assembly for a micro puree machine is disclosed. The extrusion assembly includes a plunger drive inhibitor configured to restrict input torque applied to the extrusion assembly from transferring to the extrusion drive train and the extrusion plunger. The plunger drive inhibitor may be implemented with various mechanisms, including a slip clutch assembly (with or without a frictional cone brake), a torsion spring, and/or an automated slip clutch assembly configured to cut power to the extrusion drive train when slipping of the clutch plates is detected.

### CROSS-REFERENCE TO RELATED APPLICATIONS

This application is a continuation-in-part of U.S. patent application Ser. No. 18/531,807, filed Dec. 7, 2023, which claims priority to and the benefit of U.S. Provisional Patent Application No. 63/578,744, filed Aug. 25, 2023, entitled “Extrusion Lever Mechanism for a Micro Puree Machine,” the contents of which are incorporated herein by reference as though fully set forth herein.

### FIELD

The present disclosure relates to a food processing device and, more particularly, to a micro puree machine with an extrusion assembly having a plunger drive inhibitor.

### BACKGROUND

Domestic kitchen appliances that are intended to make ice creams, gelatos, frozen yogurts, sorbets, and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are impractical for preparing most non-dessert food products.

An alternative type of machine known for making a frozen food product is what is referred to herein as a micro-puree machine. Typically, machines of this nature spin and plunge a blade into a pre-frozen ingredient or combination of ingredients. While able to make frozen desserts like ice creams, gelatos, frozen yogurts, sorbets and the like, micro-puree style machines can also prepare non-dessert types of foods such as non-dessert purees and mousses.

### SUMMARY

In some embodiments, the disclosure describes an extrusion assembly for a micro puree machine. The extrusion assembly uses a plunger to extrude ingredients from a bowl. Movement of the plunger may be controlled using a lever that is manually rotated by a user. Torque exerted on the lever (with or without the assistance of a motor) is transferred to the extrusion drive train to move the plunger through the bowl. However, if the contents within the bowl are too hard (e.g., unprocessed ingredients, under-processed ingredients, if foreign objects are present, etc.), damage can occur when extruding or attempting to extrude the contents of the bowl. Possible types of damage that can occur if too much force is exerted on certain components of the extrusion assembly include drive train damage (e.g., damage to gears, leadscrew, motor, etc.), damage to the bowl, and/or damage to the main housing of the micro puree machine.

To protect the drive train and other componentry of the extrusion assembly, a plunger drive inhibitor and/or decoupler may be used to selectively restrict or eliminate force input torque (e.g., manual force applied to the extrusion lever or input force applied by a motor) from being applied to the extrusion drive train. The plunger drive inhibitor can be configured to restrict input torque from reaching the extrusion drive train if the amount of force encountered by the plunger is above a predetermined safe limit and/or threshold. The plunger drive inhibitor may utilize various different mechanical and/or electrical features to restrict input force from transferring to the extrusion drive train. Some of these force-limiting mechanisms are described below. For example, the plunger drive inhibitor may, in some implementations, utilize a slip clutch assembly (which may be referred to herein as simply a “slip clutch”) in which a first clutch plate and a second clutch plate rotate together to transfer rotational force to the extrusion drive train during normal use, and the clutch plates slip relative to one another when the level of force exceeds the predetermined safe limit and/or threshold, such that rotational force is not transferred to the extrusion drive train. If desired, the slip clutch assembly may be automated in that input torque is delivered to an input shaft by a motor and the extrusion drive train is electrically halted when slipping of the clutch plates is detected, for example, by a microswitch or other electrical feature. In some implementations, a frictional cone brake may be used in connection with the slip clutch assembly to contact the slipping clutch plate as it translates axially to restrict further translation. In alternative implementations, the plunger drive inhibitor and/or decoupler utilizes a torsion spring to restrict input force from reaching the extrusion drive train if the force required to move the plunger is above a level deemed to be safe. The plunger drive inhibitors described here can each prevent input torque from being transmitted to the extrusion drive train if the level of force required to move the plunger within the bowl is determined to be above a predetermined force limit and/or threshold. The plunger drive inhibitors and decouplers thus protect the extrusion drive train from experiencing unsafe levels of force.

While various embodiments of the disclosure are described in relation to a lever and plunger of a micro-puree machine, it should be appreciated that the invention is not so limited. For example, embodiments of the slip clutch assembly, micro-switch and other components may be used with devices other than a micro-puree machine, for example, other types of devices for processing food.

In some aspects, an extrusion assembly for a micro puree machine is described. The micro puree machine includes a bowl having an opening and at least one sidewall defining an interior volume, a plunger, and a plunger drive inhibitor. The plunger drive inhibitor may be implemented with a slip clutch or a torsion spring. The plunger is engageable with a driven shaft configured to axially move the plunger within the interior volume of the bowl to cause ingredients within the interior volume to be extruded from the opening. The slip clutch is configured to restrict axial movement of the plunger within the interior volume of the bowl when a predetermined force limit is reached or exceeded.

The slip clutch may have a first clutch plate and a second clutch plate configured to rotate together below the predetermined force limit and to rotate relative to one another above the predetermined force limit. In some such implementations, the second clutch plate drives rotation of the driven shaft and, when above the predetermined force limit, rotational force is restricted from the driven shaft. The extrusion assembly may also include a motor arranged to drive rotation of the first clutch plate. The slip clutch may also include a spring that exerts a spring force on the first clutch plate to maintain contact with the second clutch plate and the spring force is parallel to a central axis of the slip clutch. In some implementations, the first clutch plate includes a first surface and the second clutch plate includes a second surface, the first surface is in contact with the second surface, and the first surface and the second surface are each angled with respect to a plane intersecting a central axis of the slip clutch. Above the predetermined force limit, the first clutch plate or the second clutch plate may translate axially along a central axis of the slip clutch. In some such implementations, the micro puree machine also includes a microswitch to electrically monitor axial translation of the first clutch plate or the second clutch plate. The microswitch may be configured to send an electrical signal to a microcontroller to stop rotation of the driven shaft if axial movement of the first clutch plate or the second clutch plate is detected. In some implementations, the micro puree machine may also include a frictional cone brake having a conical surface shaped to engage a conical surface of the first clutch plate when the predetermined force limit is exceeded.

The micro puree machine may also include a lever configured to deliver an input force to the plunger drive inhibitor. In some implementations, the plunger drive inhibitor includes a torsion spring having a first end and an opposed second end, the first end being connected to the lever and the second end being connected to an input shaft for the driven train. The torsion spring may be preloaded with a defined torque correlating to the predetermined force limit, and wherein below the predetermined force limit, rotational force applied to the lever is fully transferred to the input shaft for the driven train and, above the predetermined force limit, rotational force applied to the lever causes the torsion spring to experience non-permanent spring deformation.

In some aspects, an automated slip clutch assembly for a micro puree machine is disclosed. The automated slip clutch assembly includes a first clutch plate, a second clutch plate, a spring positioned to force the first clutch plate into contact with the second clutch plate, an input shaft connected to the first clutch plate, and an output shaft connected to the second clutch plate. The automated slip clutch assembly may be configured to transfer rotational force applied to the input shaft to the output shaft when a force level applied to the input shaft is below a predetermined slip threshold and wherein when a force level applied to the input shaft is above the predetermined slip threshold, force applied to the input shaft is not transferred to the output shaft.

In some implementations, the first clutch plate includes a first surface and the second clutch plate comprises a second surface, the first surface is in contact with the second surface, and wherein the first surface and the second surface are each angled with respect to a plane intersecting the central axis of the automated slip clutch assembly. In these and other implementations, above the predetermined slip threshold, the first clutch plate or the second clutch plate translates axially along a central axis of the automated slip clutch assembly. The automated slip clutch assembly may also include a microswitch positioned to electrically monitor axial translation of the first clutch plate or the second clutch plate and to send an electrical signal if axial translation is detected. The input shaft may be arranged to rotate in a first rotational direction for extrusion and to rotate in a second rotational direction opposite the first rotational direction for retraction. In some such implementations, the automated slip clutch assembly may have a predetermined slip threshold for extrusion and a predetermined slip threshold for retraction and the predetermined slip threshold for extrusion is unequal to the predetermined slip threshold for retraction. The predetermined slip threshold for retraction may be greater than the predetermined slip threshold for extrusion.

In yet another aspect, a self-contained automated slip clutch assembly is disclosed. The self-contained automated slip clutch assembly includes a first clutch plate, a second clutch plate, a spring plate, and a spring positioned to exert a spring force on the spring plate and the first clutch plate. The self-contained automated slip clutch assembly may be configured to transfer rotational force applied to the first clutch plate to the second clutch plate when a force level applied to the first clutch plate is below a predetermined slip threshold and wherein when a force level applied to the first clutch plate is above the predetermined slip threshold, rotational force applied to the first clutch plate is not transferred to the second clutch plate.

In some implementations, below the slip threshold, the spring rotates around a central axis of the self-contained automated slip clutch assembly with the first clutch plate and the second clutch plate. In these and other implementations, above the slip threshold, the second clutch plate may translate axially along a central axis of the self-contained automated slip clutch assembly. The first clutch plate may be arranged to rotate in a first rotational direction for extrusion and to rotate in a second rotational direction opposite the first rotational direction for retraction, and the self-contained automated slip clutch assembly has a predetermined slip threshold for extrusion and a predetermined slip threshold for retraction and the predetermined slip threshold for extrusion is unequal to the predetermined slip threshold for retraction. In these and other implementations, the predetermined slip threshold for retraction is greater than the predetermined slip threshold for extrusion.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

Reference to the detailed description, combined with the following figures, will make the disclosure more fully understood, wherein:

FIG. 1A shows an isometric view of a micro-puree machine, according to some embodiments of the disclosure;

FIG. 1B shows the micro-puree machine of FIG. 1A with the bowl assembly disassembled from the housing, according to some embodiments of the disclosure;

FIGS. 1C-1G illustrate embodiments of extrusion assemblies, bowl assemblies, and/or nozzle assemblies of the micro-puree machine of FIG. 1A, according to some embodiments of the disclosure;

FIG. 2A illustrates a portion of another micro-puree machine, according to some embodiments of the disclosure;

FIG. 2B illustrates a reversible bowl assembly that may be coupled to the micro-puree machine of FIG. 2A, according to some embodiments of the disclosure;

FIG. 3A shows another reversible bowl assembly, according to some embodiments of the disclosure;

FIG. 3B shows a blade of the reversible bowl assembly of FIG. 3A, according to some embodiments of the disclosure;

FIG. 3C is a cut-away view of the reversible bowl assembly and first lid of FIGS. 3A and 3B, according to some embodiments of the disclosure;

FIG. 3D shows a detailed view of an embodiment of a plunger coupled to the underside of second lid, according to some embodiments of the disclosure;

FIGS. 4A and 4B illustrate the use of the reversible bowl assembly of FIGS. 3A-3D, according to some embodiments of the disclosure;

FIG. 5 illustrates an aeration system, according to some embodiments of the disclosure;

FIGS. 6A-6L illustrate another micro-puree machine, according to some embodiments of the disclosure;

FIG. 6M illustrates another micro-puree machine, according to some embodiments of the disclosure;

FIGS. 7A-7D illustrate another extrusion assembly, according to some embodiments of the disclosure;

FIGS. 8A-8C illustrate another extrusion assembly, according to some embodiments of the disclosure;

FIGS. 8D-8J illustrate the use of the extrusion assembly of FIGS. 8A-8C, according to some embodiments of the disclosure;

FIG. 9A illustrates another extrusion assembly, according to some embodiments of the disclosure;

FIGS. 9B-9H illustrate the use of the extrusion assembly of FIG. 9A, according to some embodiments of the disclosure;

FIGS. 10A-10F illustrate the use of another extrusion assembly, according to some embodiments of the disclosure;

FIG. 11A illustrates a plunger drive inhibitor with a slip clutch assembly, according to some implementations of the disclosure;

FIG. 11B shows a cross-section view of the plunger drive inhibitor illustrated in FIG. 11A;

FIG. 11C shows an exploded view of the plunger drive inhibitor illustrated in FIG. 11A;

FIG. 12 illustrates features of the slip clutch assembly shown in FIG. 11A;

FIG. 13A shows cross-sectional views of the plunger drive inhibitor of FIG. 11A with the slip clutch assembly not slipping while the lever moves between the home position and the maximum open position;

FIG. 13B shows cross-sectional views of the plunger drive inhibitor of FIG. 11A with the slip clutch assembly slipping while the lever moves between the home position and the maximum open position;

FIG. 14 illustrates a plunger drive inhibitor having a slip clutch assembly and a microswitch to detect slipping, in accordance with some implementations of the present disclosure;

FIG. 15A illustrates a cross-sectional view of a plunger drive inhibitor with a slip clutch assembly and a frictional cone brake, in accordance with some implementations of the present disclosure;

FIG. 15B illustrates the plunger drive inhibitor of FIG. 15A while the slip clutch assembly is slipping;

FIG. 15C illustrates an isometric view of the plunger drive inhibitor of FIG. 15A, illustrated without the frictional cone brake;

FIG. 15D illustrates a frictional cone brake, in accordance with some implementations of the present disclosure;

FIG. 16A illustrates a cross-sectional view of a plunger drive inhibitor having a torsion spring, in accordance with some implementations of the disclosure;

FIG. 16B illustrates an isometric view of the torsion spring shown in FIG. 16A;

FIG. 17 illustrates a plunger drive inhibitor with an automated slip clutch assembly configured to stop the extrusion drive train when slipping between the clutch plates is electronically detected, in accordance with some implementations of the present disclosure;

FIG. 18A illustrates an exploded view of a first clutch plate and a second clutch plate for an automated slip clutch assembly of a plunger drive inhibitor, in accordance with some implementations of the disclosure;

FIG. 18B illustrates a cross-sectional side view of the first clutch plate and the second clutch plate illustrated in FIG. 18A;

FIG. 19 illustrates a side profile view of the first clutch plate illustrated in FIGS. 18A and 18B;

FIG. 20A illustrates a cross-sectional view of a plunger drive inhibitor with an automated slip clutch assembly, in accordance with some implementations of the disclosure; and

FIG. 20B illustrates an isometric view of the automated slip clutch assembly shown in FIG. 20A.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (i.e., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

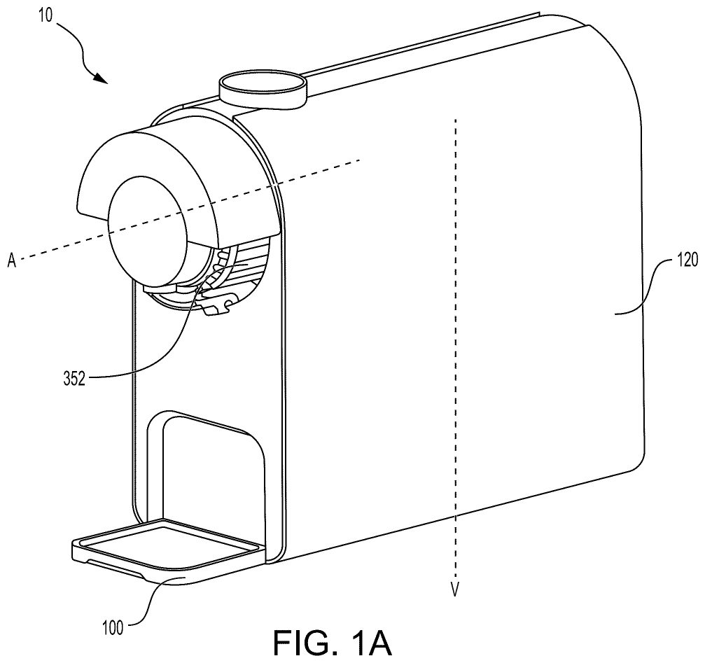

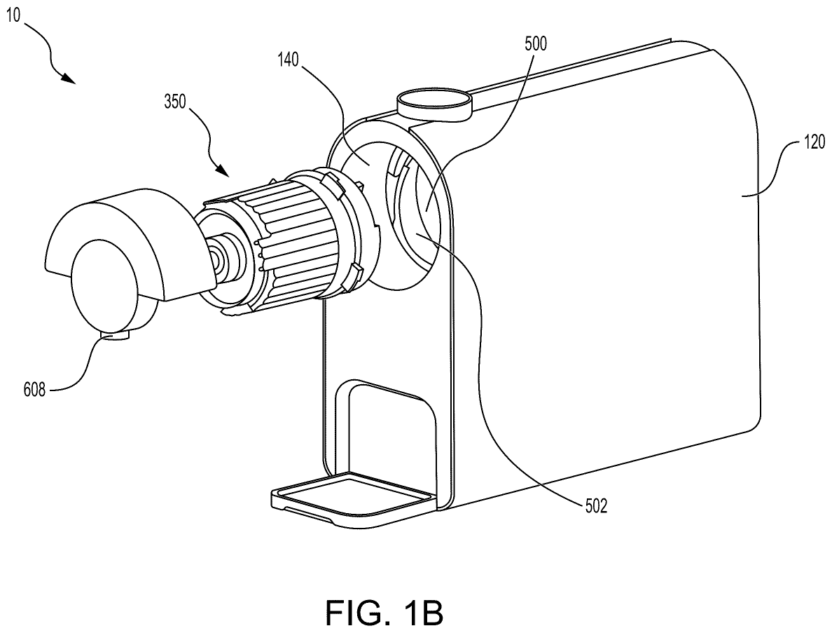

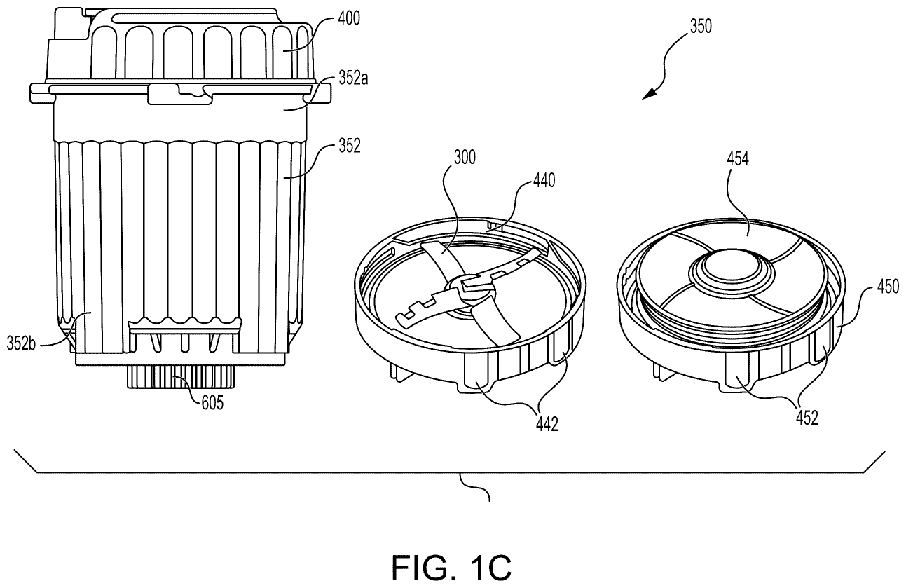

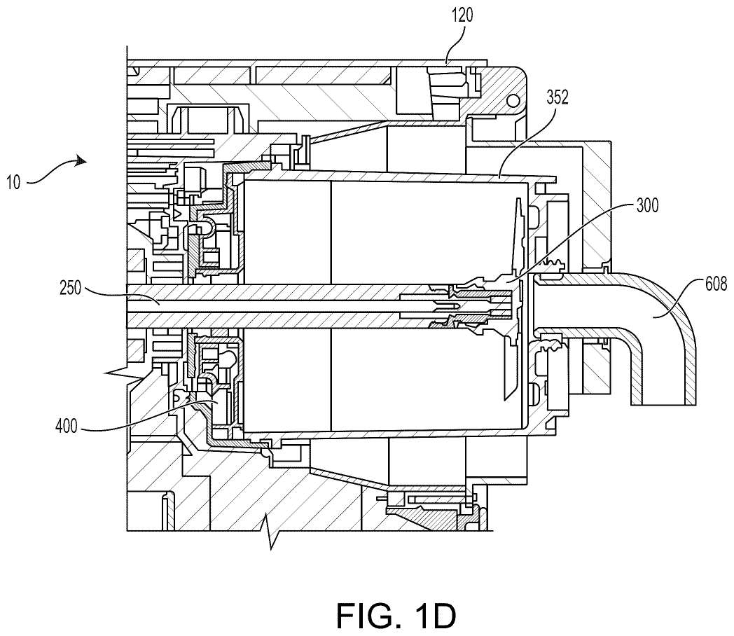

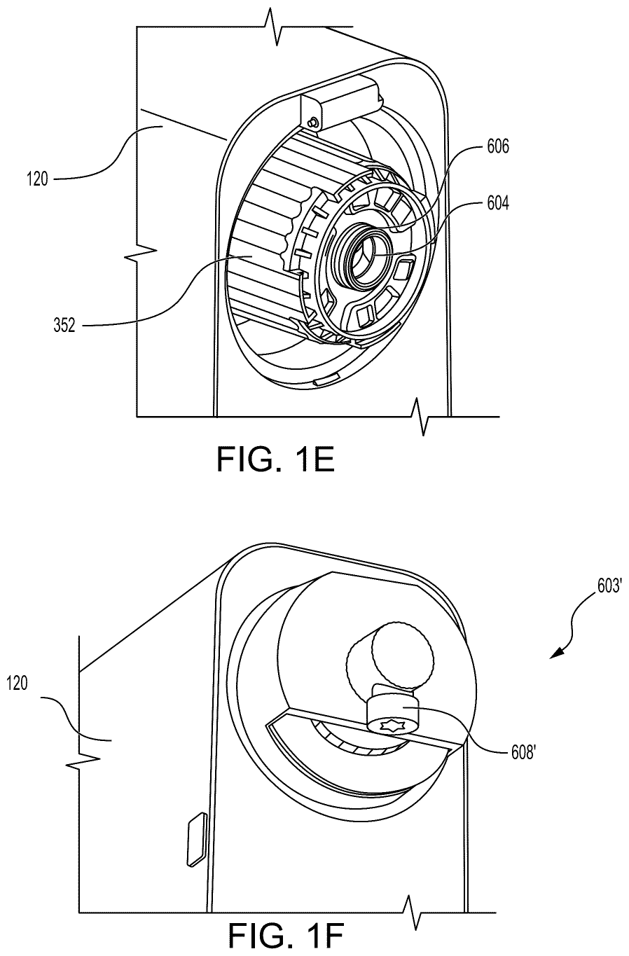

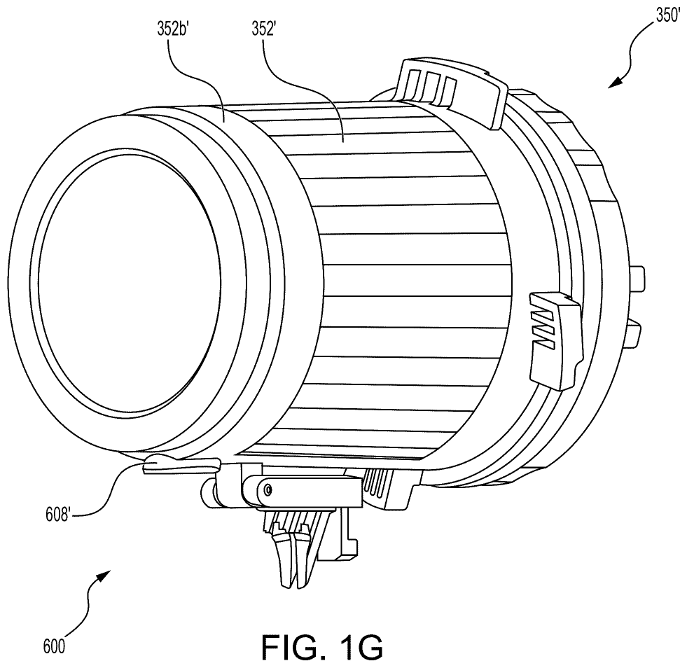

FIG. 1A shows an isometric view of a micro-puree machine 10, according to some embodiments of the disclosure. FIG. 1B shows the micro-puree machine 10 of FIG. 1A with the bowl assembly 350 disassembled from the housing 120 according to some embodiments of the disclosure. FIGS. 1C-1G illustrate embodiments of the extrusion assemblies, bowl assemblies, and/or nozzle assemblies, according to some embodiments of the disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 605 may be referred to herein as an extrusion assembly. The nozzle assembly 603 may include a nozzle housing 607 and a nozzle 608.

The bowl assembly 350 may include a bowl and/or container 352 (also referred to as a beaker) configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating, LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating, LLC, the entire contents of which are hereby incorporated by reference (the '756 patent). In embodiments, the bowl and/or container 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may including a coupling 500 disposed within an opening 140 of the housing 120. An inner surface 502 of the coupling 500 may comprise locating and locking elements for positioning and connecting the bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 patent. When the lid 440 is coupled to the bowl 352 (e.g., via reciprocal threading on the bowl and lid), the bowl assembly 350 may be considered to be in a processing configuration, and may be coupled to the housing via coupling 500. The lid 440 may have locating and locking elements 442 on its exterior sidewall configured to couple to the locating and locking elements on the inner surface 502 of the coupling 500. The second lid 450 may include a plunger 454 for extruding ingredients. The plunger 454 may furthermore include a flexible seal around its perimeter to ensure contact (e.g., maximum contact) with the sidewall of the bowl 352 to allow for optimal (e.g., maximum) extrusion yield. When the lid 450 is coupled to the bowl 352 (e.g., via reciprocal threading on the bowl and lid), the bowl assembly 350 may be considered to be in an extruding configuration, and may be coupled to the housing via coupling 500. The lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar 606. The coupling collar 606 may include threading or other types of coupling features, for example, slots or cams, e.g., for bayoneting. The opening 604 may be enclosed by a cap 605, for example, during processing, which cap may be removed during extruding. The cap 605 may include interior threading (not shown) or other coupling features that allow it to couple to the coupling collar 606. The opening 604 may further be in fluid communication with a nozzle 608. For example, the opening 604 may be in fluid communication with a nozzle through a conduit (e.g., plastic tubing) that extends from the opening 604 to the nozzle 608, e.g., within nozzle assembly 603. In embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The lid 440 may be configured (e.g., as described in the '765 patent) such that, when the lid 440 is coupling to the housing 120, the blade 300 engages a driven shaft 250 and disengages the lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 350 (and perhaps to the housing) even when extrusion is not being performed, e.g., during processing. In such embodiments, the opening 604 may be closed, for example, using cap 605 or by other means. FIG. 1E is a bottom view of the bowl assembly 350 while coupled to the housing, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with lid 450 on the first end 352a, couple the nozzle assembly to the second end 352b of the bowl assembly 350 if not already attached, couple the bowl assembly 350 to the housing 120, and initiate extrusion via the user interface. During extrusion, the driven shaft drives the plunger 602 from the first end 352a of the bowl 352 to the second end 352b of the bowl, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′ including the extrusion assembly 600 according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ maybe be the same or different than bowl assembly 350 and/or bowl 352, respectively.

Advantageously, the micro-puree machine 10 may include a sensor (not shown) that recognizes which lid is installed into the machine 10 to restrict certain programs based on the lid functions, which may prevent user error when operating the machine 10. For example, the micro-puree machine may only activate the blade 300 when the sensor detects that the bowl 352 is installed in the first configuration in which lid 440 is coupled to bowl 350, and may only activate the plunger 602 when the sensor detects that the bowl 352 is installed in the second configuration in which lid 440 is coupled to bowl 350. For example, each of lids 440 and 450 may include distinctive physical and/or electromagnetic features, e.g., as part of locating and locking elements 442 and 452, respectively, for which coupling 500 or other elements of the micro-puree machine 10 may be configured to detect and distinguish lid 440 from lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing for processing or extruding, respectively, for example, as described in the '765 patent or U.S. Pat. No. 11,882,965 to SharkNinja Operating, LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back and forth movement of the blade 300 into and out of the bowl 350 during processing, and, to move the plunger 454 into and out of the bowl 350 during extrusion. In embodiments, the micro-puree machine 10 may include gearboxes (e.g., high ratio gearboxes) and reinforced internals (not shown) to allow an extrusion assembly as described herein to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

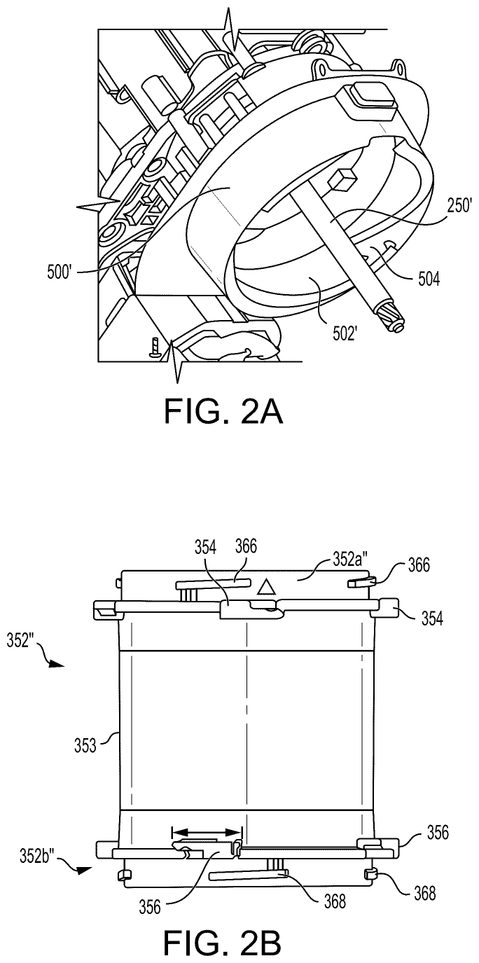

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open-that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354″ on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500 together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′ such that the projections 356 are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

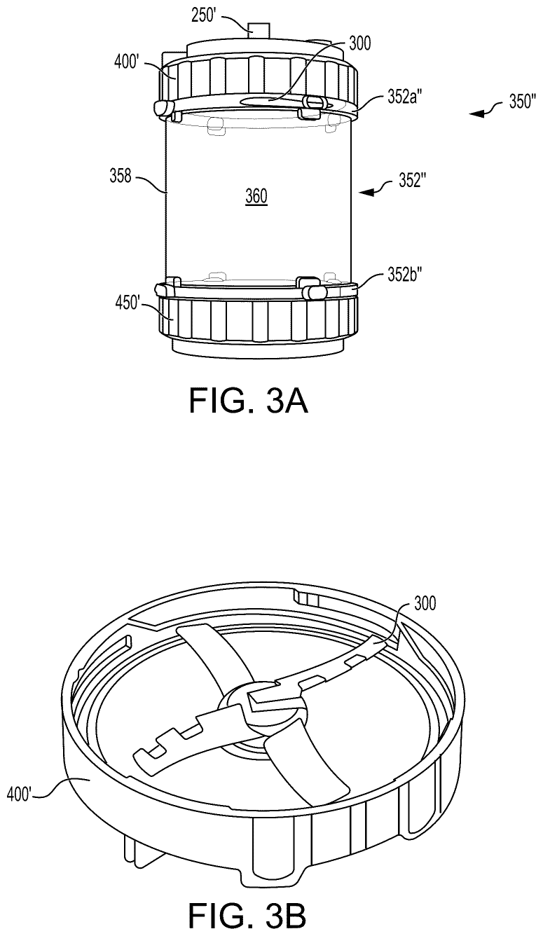

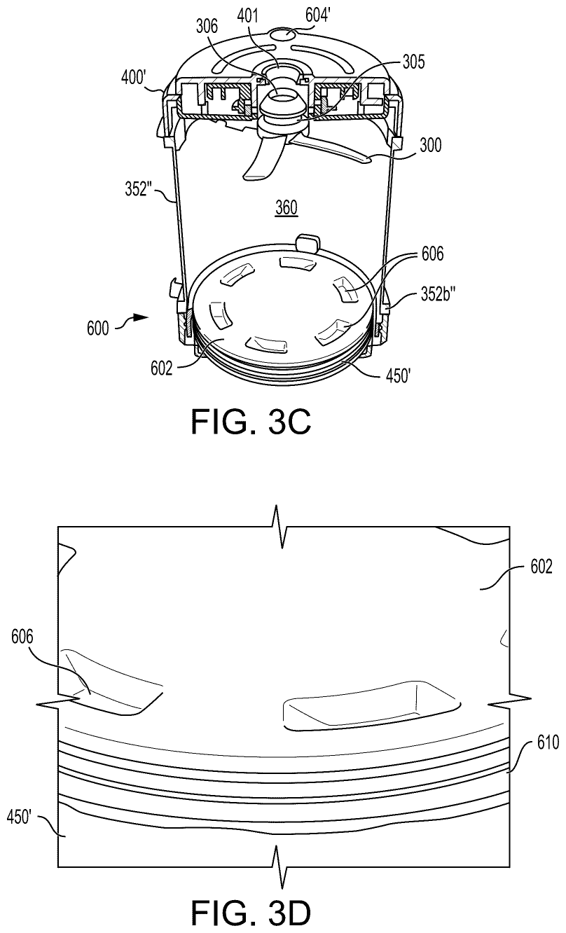

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In embodiments, the second lid 450′ may removably couple to the second open end 352b″ of the bowl 352″. The second lid 450′ may include, or be coupled to, a plunger 602 for pushing the ingredients in the bowl 352″ toward an opening 604 in first lid 400′. The plunger 602, alone or in combination with other components (e.g., the second lid 450′, the bowl 352″, or the nozzle 608), may constitute an extrusion assembly 600 for extruding processed ingredients from the bowl 352″. The opening 604′ in the first lid 400′ may further be in fluid communication with a nozzle (e.g. nozzle 608). For example, the opening 604′ may be in fluid communication with a nozzle through a conduit (e.g., plastic tubing) that extends from the opening 604′ to the nozzle. In embodiments, such a conduit may include one or more sections connected by joints (e.g., an elbow joint) to translate the direction (e.g., horizontal) of extrusion from opening 604 to a direction (e.g., vertically downward) of extrusion from the nozzle.

The plunger 602 may be couplable to the driven shaft 250′ of the micro-puree machine when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4B and 4B may include one or more motors and a transmission system (e.g., including gearing) that drive a driven shaft (e.g., driven shaft 250′) for engaging the blade assembly 300 and/or plunger 602 when the bowl assembly 350″ (coupled to lid 400′ or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

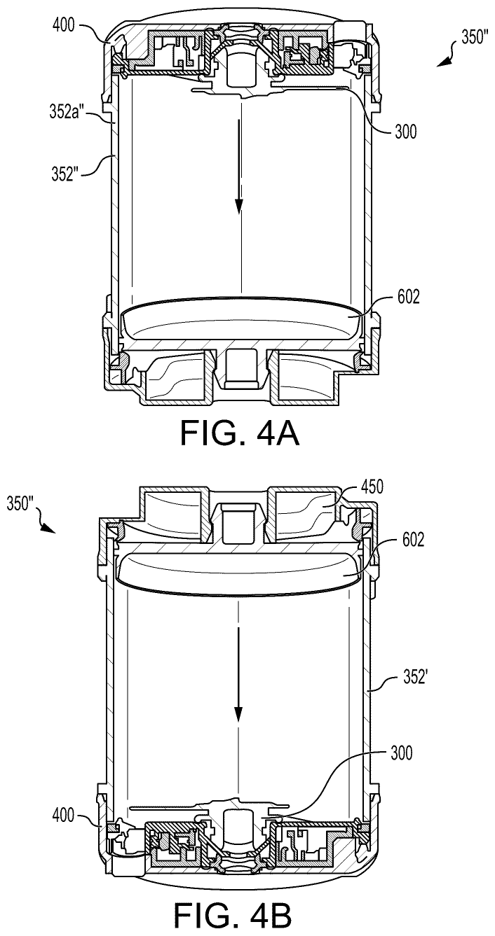

FIGS. 4A and 4B illustrate the use of the reversible bowl assembly 350″ according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user then may then remove the bowl assembly 350″ from the coupling 500′, reverse the orientation of the bowl assembly 350″ (i.e., flip the bowl assembly 350″) and reinstall the second end 352b″ of the bowl 352″ to the coupling 500′ in the second configuration. The user then may select a desired program at the user interface to descend the plunger 602 to extrude the ingredients out through the opening 604′ in the first lid 400′. For example, the plunger 602 may descend into the ingredients to extrude the ingredients out through the opening 604′ and then ascend from the opening 604′ after the extrusion is complete.

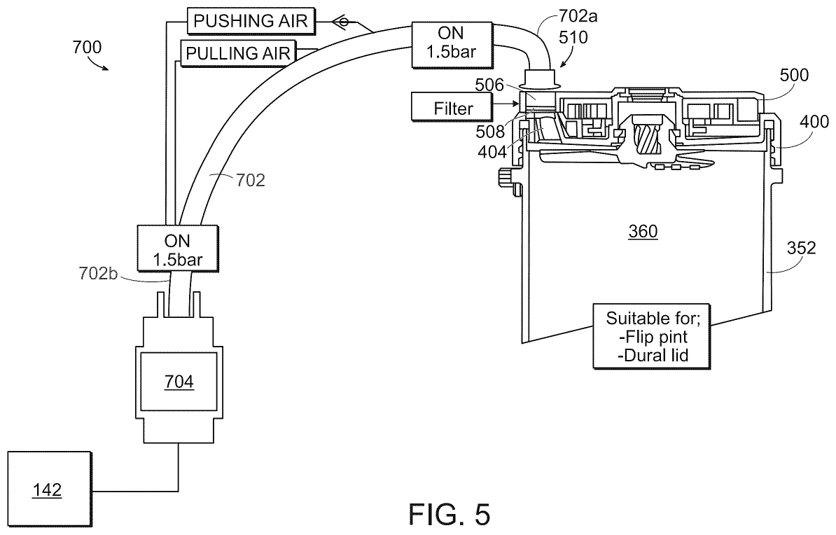

FIG. 5 illustrates an aeration system 700 for use with the micro-puree machine 10, according to some embodiments of the disclosure. As shown in FIG. 5, the aeration system 700 may comprise an opening 506 in the coupling 500. When the bowl 352 is in the first configuration, the interior volume 360 may be substantially sealed from ambient air. The opening 506 may include a filter 508 for filtering dust particles and debris from entering the interior volume 360. A first end 702a of a tube 702 may operatively attach to the opening 506 via a pliable stopper 510 (for example, a silicone bung) such that the tube 702 is in fluid communication with the interior volume 360. A second end 702b of the tube 702 may operatively couple to a pump 704 or other mechanism for forcing fluids (e.g., pushing air) in fluid communication with the tube 702. The pump 704 may be operable to change a pressure of the interior volume 360 of the bowl 352 by selectively pumping gas (e.g., air) into or pulling gas (e.g., air) out of the interior volume 360 during processing. The addition of air or gas to the ingredients during processing may allow a user to change a density and texture of the final product. For example, processing the ingredient under a high pressure (for example, 8 psi) results in a lighter and airier output. In embodiments, the aeration system 700 may be integrated into a processing program on the user interface 142 with a predetermined processing time and aeration percentage. The disclosure also contemplates that the user interface 142 would have a separate aeration input to allow for further user control.

While embodiments of the disclosure including performing processing and extrusion using a same driven shaft, in some embodiments, processing and extrusion are performed on different shafts, as will now be described.

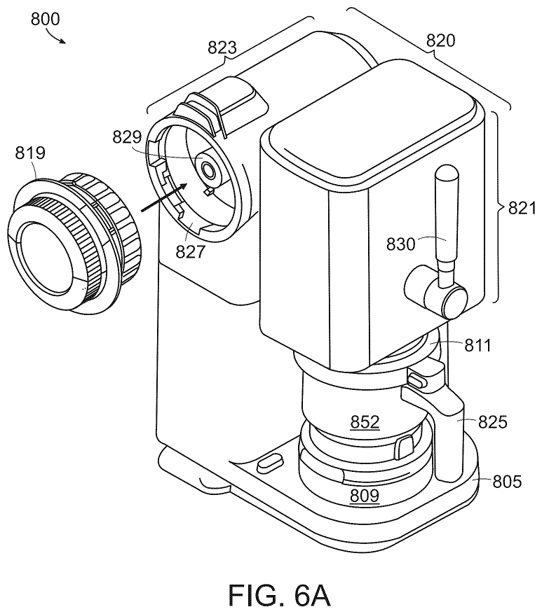

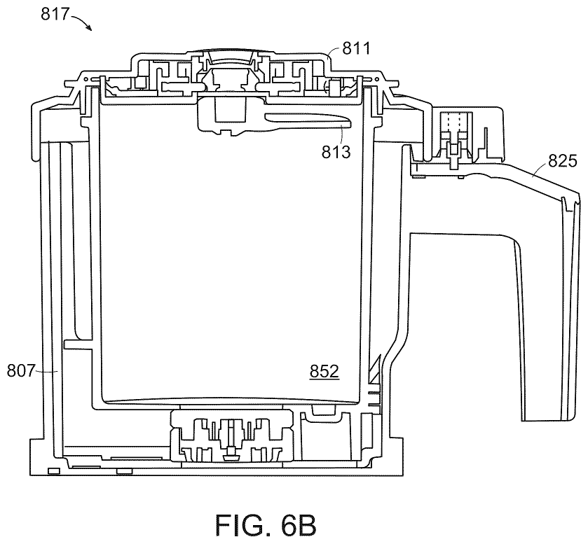

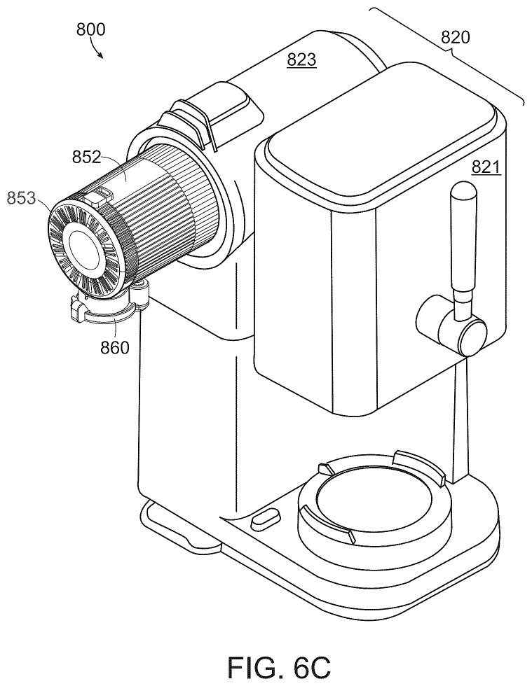

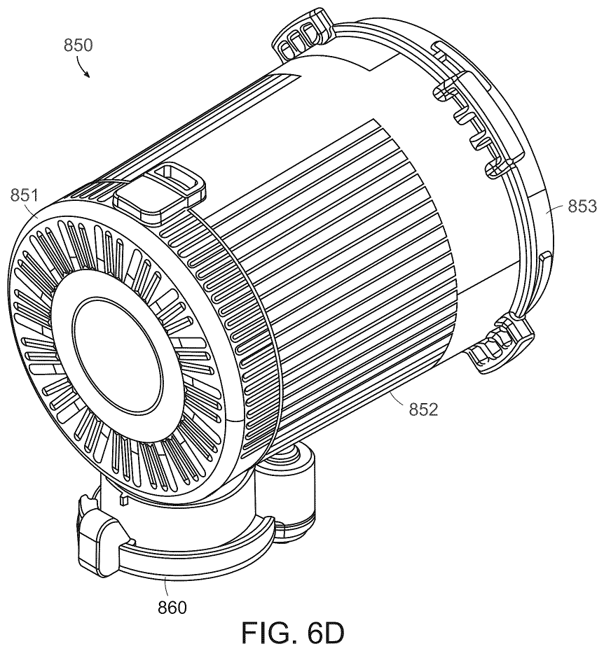

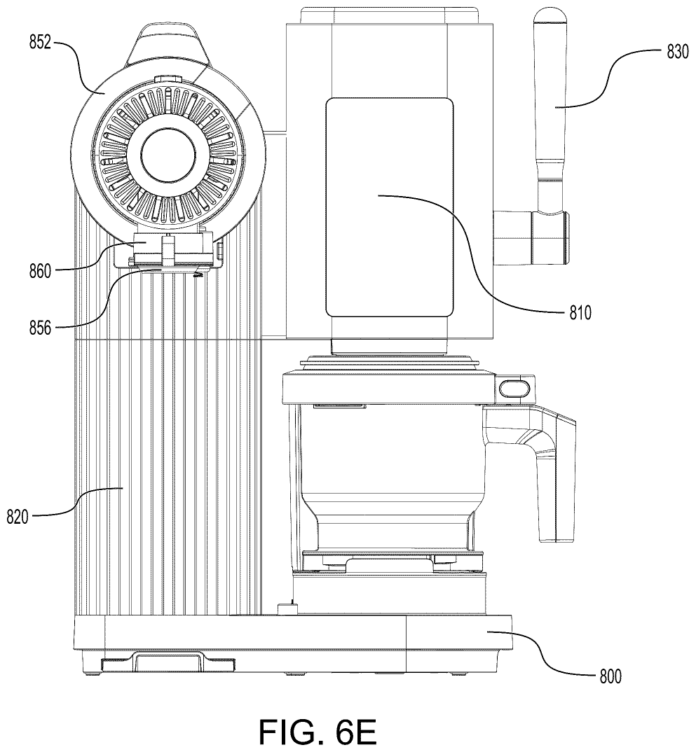

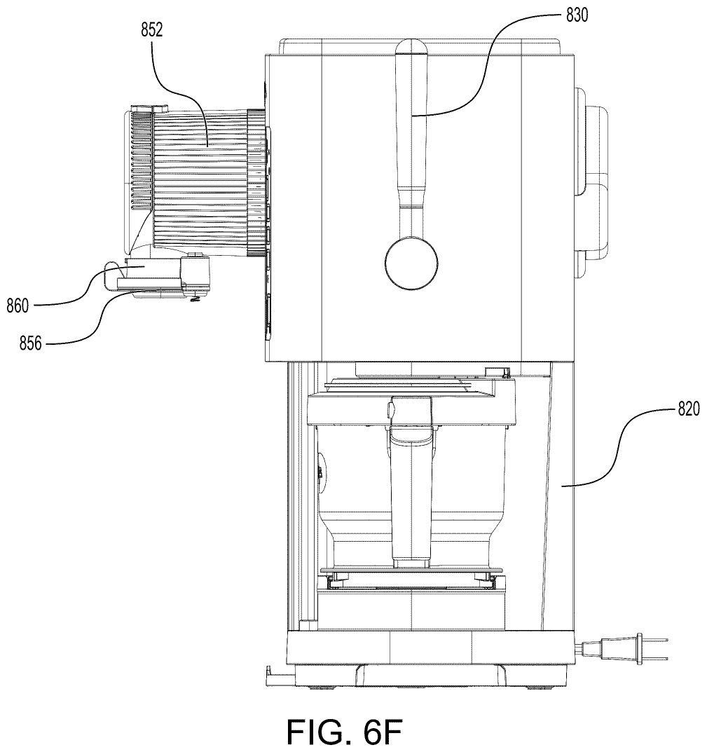

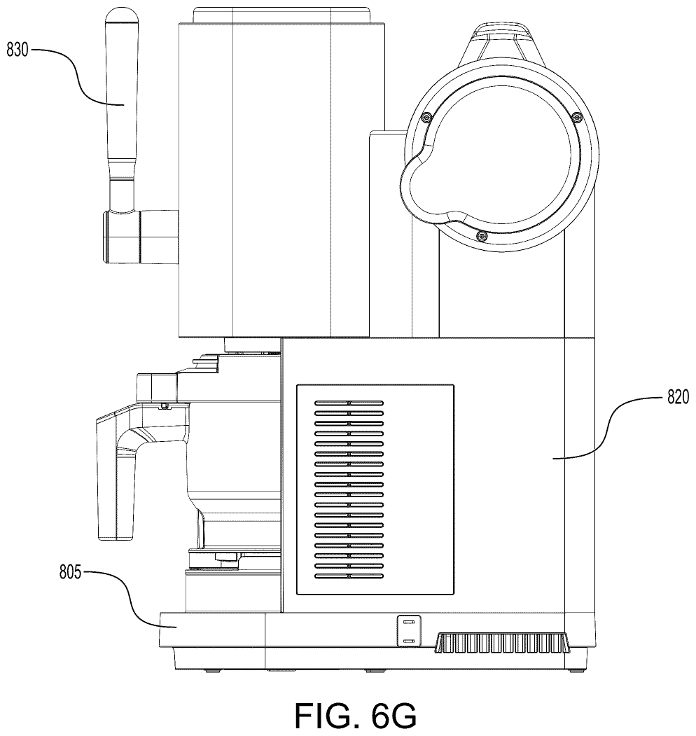

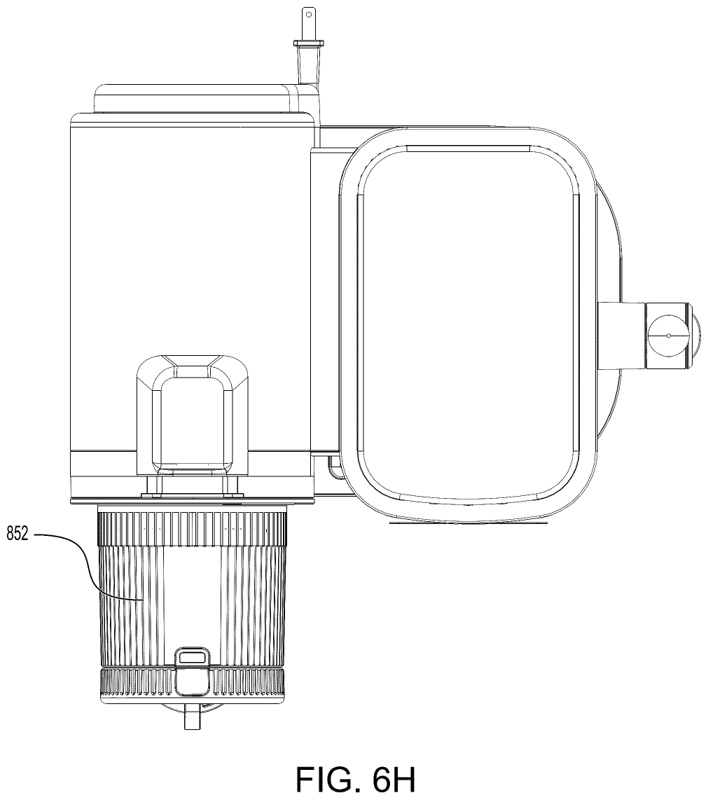

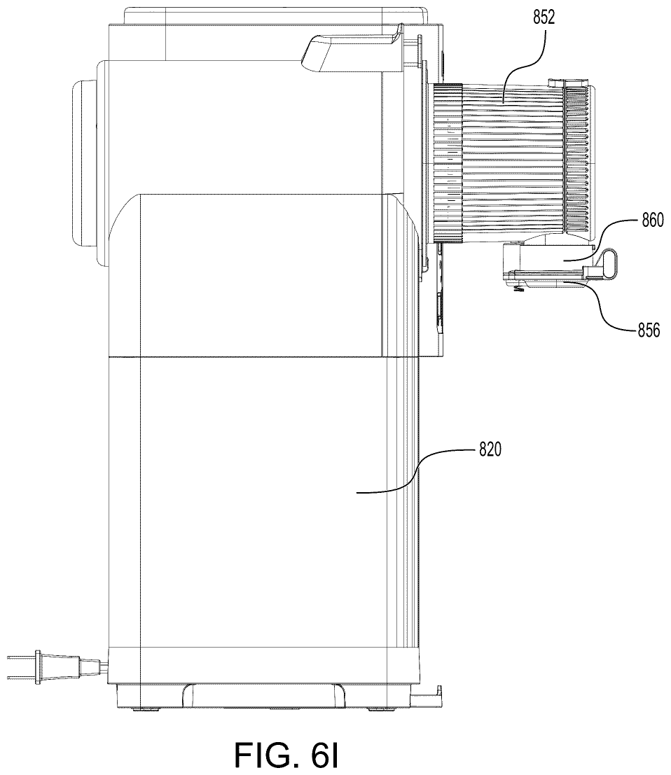

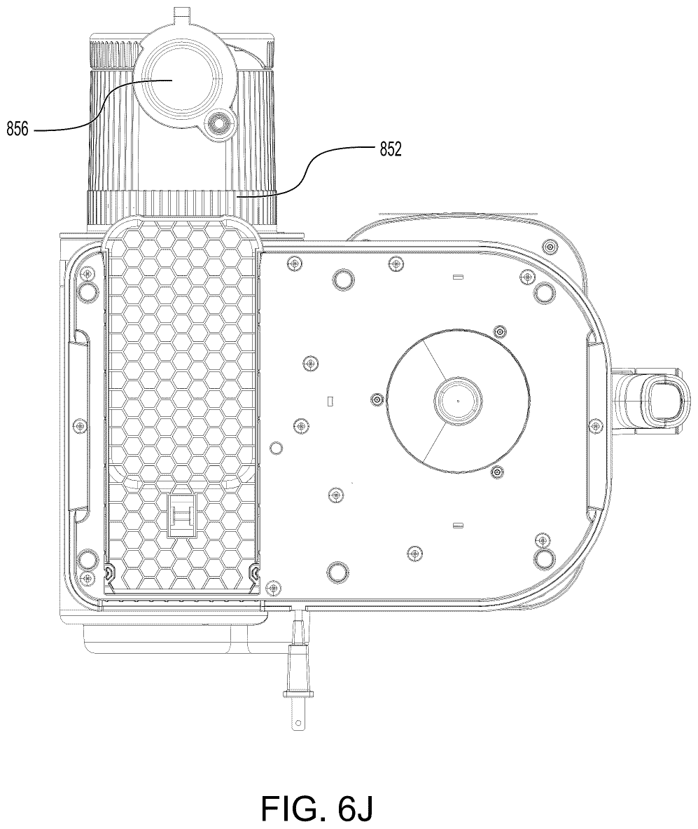

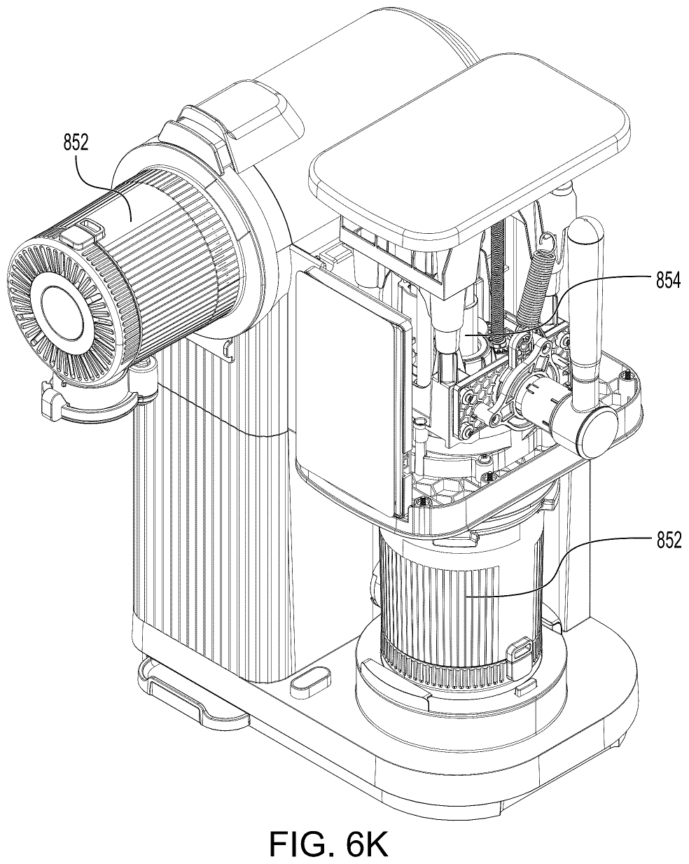

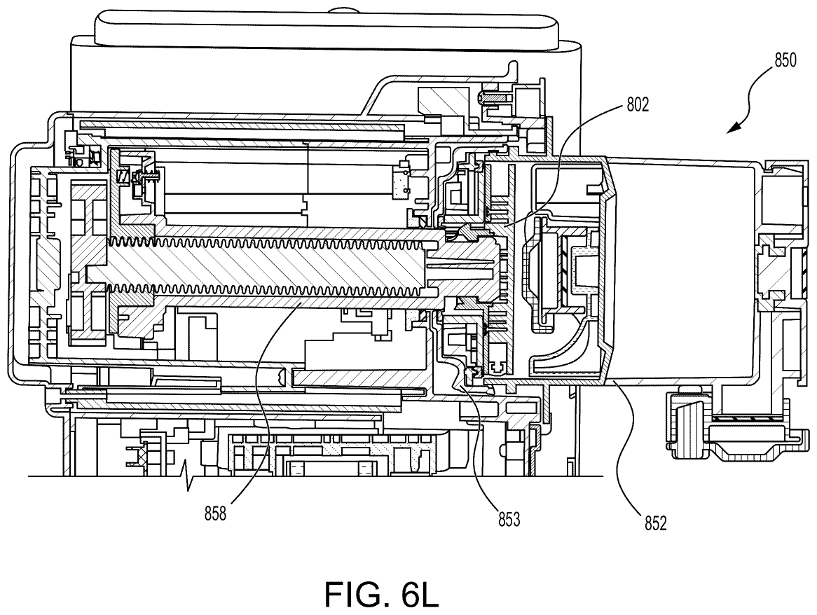

FIGS. 6A-6L illustrate another micro-puree machine 800, according to some embodiments of the disclosure. FIGS. 6A and 6B illustrate an embodiment of micro-puree machine 800 in a first configuration for processing (e.g., micro-pureeing), which may be referred to herein as a processing configuration. FIGS. 6C and 6D illustrate an embodiment of micro-puree machine 800 in a first configuration for extruding, which may be referred to herein as an extruding or extrusion configuration. FIGS. 6E-6L illustrate an embodiment of micro-puree machine 800 in both processing and extruding configurations merely for illustrative purposes, as in some embodiments, the micro-puree is not configured to perform processing and extruding concurrently.

The micro-puree machine 800 may include a base 805 and a housing 820. The housing 820 may include a user interface 810 for receiving user inputs to control the micro-puree machine 800 and/or display information. In some embodiments, the micro-puree machine includes a processing sub-module 821 including one or more components configured to process ingredients in a bowl 852 (e.g., bowl 352 or a variation thereof) and an extruding sub-module 823 including one or more components configured to extrude processed ingredients from the bowl 852. In a processing configuration, the bowl 852 may be coupled to the interior of an outer bowl 807 that is mounted on a processing platform 809 mounted to the base 805. The bowl 852 may be coupled to a lid 811 (e.g., lid 442 or a variation thereof) that houses a blade assembly 813 (e.g., blade 300 or a variation thereof). The bowl 852 may include a nozzle control assembly 851 (e.g., a dial) that enables a user to control an opening or closing of a nozzle 860, a nozzle 860, and a hinged stopper or plug 856 that can be used by a user to selectively cover the nozzle 860, or the control assembly 851. In some embodiments, the nozzle control assembly 851, the nozzle 860, and the stopper 856 may be removably attachable to the bowl 852. Using the handle 825, a user may rotate and elevate the processing bowl assembly 817 into a processing position in which the blade assembly 813 engages with a driven shaft 854, the lid 811 couples to the micro-puree machine, and the blade 300 is released from the lid 811 so the driven shaft 854 can drive the shaft 854, for example, as described in the '765 application. By engaging the user interface (or via a remote interface wirelessly connected to a wireless interface within housing 820), the user may initiate processing of the ingredients in the bowl 852. In a processing configuration, extruding sub-module 823 may remain idle, and a cap or plug 819 may be coupled to a coupling 827, covering an interface 829 with driven shaft 858.

After the processing of the ingredients, the processing bowl assembly 817 may be decoupled from the micro-puree machine 810 (e.g., from the processing sub-module 821), and de-mounted from the platform 809. The lid 811 may be removed from the outer bowl 807, and bowl 852 removed from the outer bowl 807. A lid 853 then may be mounted to the bowl 852, and the bowl 852 then may be coupled to the micro-processing machine 810 (e.g., to the extruding sub-module 823) in an extruding configuration.

In the extruding configuration, the bowl 852 may be coupled to a lid 853 (e.g., lid 452 or a variant thereof) that includes a plunger. The combination of the bowl 852 and the lid 853 may be referred to herein as a bowl extruding assembly 850. In embodiments, the bowl extruding assembly 850 may be configured to be installed to the micro-puree machine 800 such that the nozzle 860 faces vertically downwards when the bowl extruding assembly 850 is properly installed. The bowl extruding assembly 850 may be assembled to the housing 820 (e.g., the extruding sub-module 823) such that a central axis A of the bowl extruding assembly 850 extends perpendicular to a vertical axis V of the housing 820, as shown. The bowl extruding assembly 850 may include an outlet 860 for extruding processed ingredients from the bowl extruding assembly 850. The micro-puree machine 800 also may include a lever 830 for manually activating a plunger 802 to extrude processed ingredients within the bowl extruding assembly 850 through the outlet 860.

While the lever 830 is illustrated on a right side of the machine 800 (from the front view shown in FIG. 6B), the disclosure is not so limited. The lever 830 may be on the left side of, or another location on, the machine 800, and other components of the machine may be rearranged to accommodate the different location of the lever 830. The housing 820 may include electrical, electromagnetic, mechanical and/or electro-mechanical components to translate a pulling down or pushing up of the lever 830 into movement of a plunger (e.g. plunger 802) within the bowl 852.

Embodiments of the housing 820 of micro-puree machine 800 may house a transmission system that includes a driven shaft 854 for engaging the blade 300, a separate driven shaft 858 for engaging the plunger 802, one or more gearing systems, and one or more position and/or drive motors for moving the driven shaft 854 and the other shaft 858 rotationally and/or axially to process the ingredients in the bowl assembly 850. For example, a drive motor may drive the rotation of the driven shaft 854 and blade (e.g., blade 300) coupled thereto, and a position motor may drive the vertical (e.g., down and up) movement of the driven shaft 254 and a blade. Another motor may drive the second shaft 858 and a plunger (e.g., plunger 454 or 602) attached thereto. In embodiments, the blade 813 may be programmably controlled at the user interface 810 by a computing system to operate at different rotational speeds and moved up and down in different patterns and speeds, and for different periods of time, to make different food items. In embodiments, the plunger in the lid 853 may be programmably controlled at the user interface 810 by a computing system to operate at different rotational speeds and moved up and down in different patterns and speeds, and for different periods of time, to make different food items. Some non-limiting examples of a transmission system and the computing system are shown in described in the '765 patent and in U.S. Pat. No. 11,882,965 to SharkNinja Operating, LLC (the '965 patent), the entire contents of which are hereby incorporated by reference.

FIG. 6M shows an isometric view of a micro-puree machine 5010, according to another embodiment of the disclosure. The micro-puree machine 5010 may be used to process ingredients on one shaft and extrude the processed ingredients on another shaft. As shown in FIG. 6M, the micro-puree machine 5010 may include a base 5100, a housing 5120, and an extrusion module 5130. The housing 5120 may include a user interface (not shown) for receiving user inputs to control the micro-puree machine 5010 and/or display information. The micro-puree machine 5010 also may include a bowl 5352. The bowl 5352 may be assembled to the housing 5120 such that a central axis A of the bowl 5352 extends parallel to a vertical axis V of the housing 5120, as shown. However, the disclosure contemplates that the bowl 5352 may be assembled to the housing 5120 such that the central axis A extends at an angle of between 0 and 90° to the vertical axis V, or such that the central axis A extends perpendicular to the vertical axis V.

The extrusion module 5130 may be configured to couple to a bowl assembly as described herein, for example, a bowl having a lid with e a plunger housed therein. The extrusion module 5130 also may include a motor and transmission to drive a driven shaft to move the plunger with the bowl during extrusion, for example, as described elsewhere herein. The micro-puree machine 5010 also may include a lever 5730 for activating the plunger to extrude processed ingredients from the bowl 5352 through an integrated nozzle in the bowl 5352 (not shown). The housing 5120 may include electrical, electromagnetic and/or mechanical components the translate a pulling down or pushing up of the lever into movement of the plunger within the bowl.

The nozzle may be integrated with the bottom surface of the bowl 5352 such that nozzle faces vertically downwards when the bowl 5352 is properly installed. In the embodiment of FIG. 6J, the plunger may be configured to extrude the processed ingredients from the bowl 5352 using a separate shaft (not shown) from a driven shaft (e.g., 250) that rotates a blade (e.g., 300). In further embodiments, the separate shaft may be manually driven by the user by cranking the lever 5730.

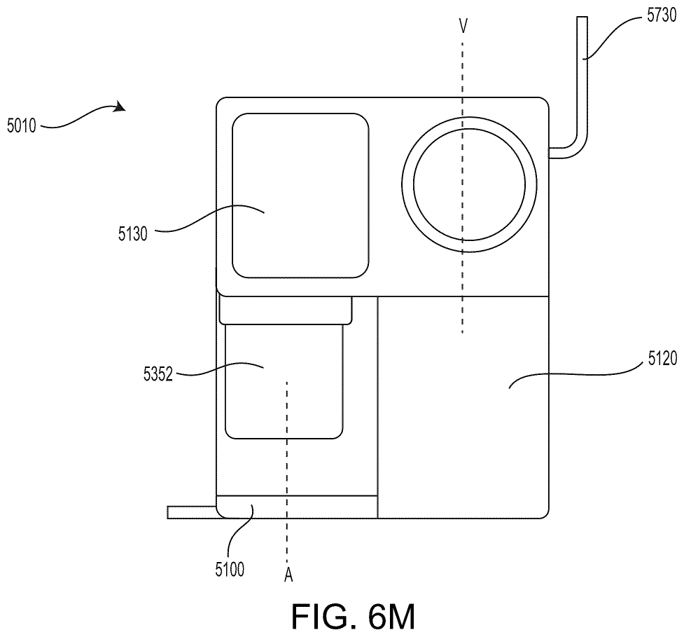

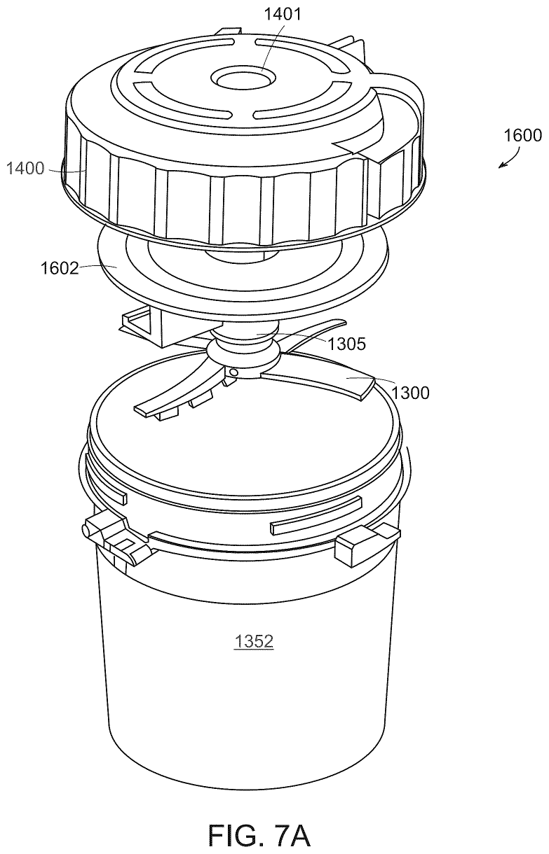

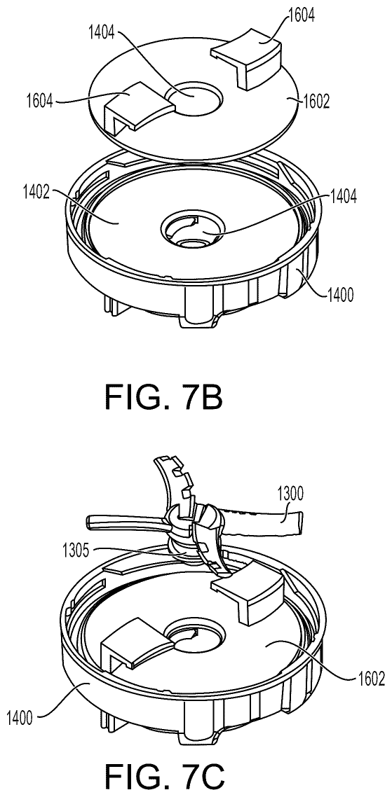

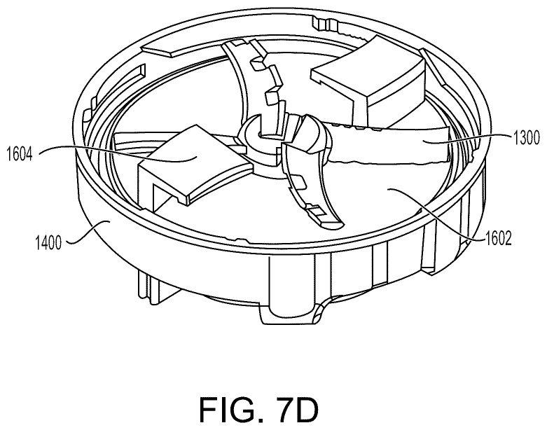

FIGS. 7A-7D illustrate another extrusion assembly 1600 in which the plunger 1602 and the blade 1300 may be installed to the same lid 1400, according to some embodiments of the disclosure. As shown in FIG. 7A, the plunger 1602, alone or in combination with other components (e.g., the lid 1400, a bowl 1352, and a nozzle), may constitute the extrusion assembly 1600 for extruding processed ingredients from the bowl 1352. In some embodiments, the bowl 1352 may be the bowl 352 including the centrally located opening 604 alignable with nozzle 608 (FIG. 4C). In other embodiments, the bowl 1352 may be the bowl 352″ including the nozzle 608″ that is integrated with the bottom edge of the bowl 352″ (FIG. 4G). The lid 1400 may define a central opening 1401 configured to allow the passage of the driven shaft 250. The blade 1300 may include a central support hub 1305 for engaging the driven shaft 250 to rotate and translate the blade 1300. As shown in FIG. 7B, the plunger 1602 may be couplable to an underside of the lid 1400. For example, the plunger 1602 may magnetically couple to a metal ring 1402 on the underside of the lid 1400. However, the disclosure contemplates other coupling mechanisms of the plunger 1602 and the lid 1400. Both the plunger 1602 and the metal ring 1402 may define openings 1404 alignable with the opening 1401 of in the lid 1400. The plunger 1602 may further include at least one retainer element 1604, as further described elsewhere herein. As shown in FIG. 7C, once the plunger 1602 has been installed on the lid 1400, a user may couple the blade 1300 to an underside of the plunger 1602 such that the central support hub 1305 extends through the openings 1404 and the blade 1300 is not blocked by the retainer elements 1604 (FIG. 7D). In use, to process ingredients within the bowl 1352, the driven shaft 250 may operate to descend the blade 1300 passed the retainer elements 1604 and away from the plunger 1602 before it begins to rotate to process the ingredients within the bowl 1352. After processing, the blade 1300 may return to its initial position against the plunger 1602. Then, to extrude the ingredients from the bowl 1352, the driven shaft 250 may operate to slightly rotate the blade 1300 such that the blade 1300 is retained against the plunger 1602 by the retaining elements 1604. Then, the driven shaft 250 may exert sufficient force to overcome the magnetic coupling between the lid 1400 and the plunger 1602 to descend both the blade 1300 and plunger 1602 through the bowl 1352 to extrude the processed ingredients through the nozzle 608.

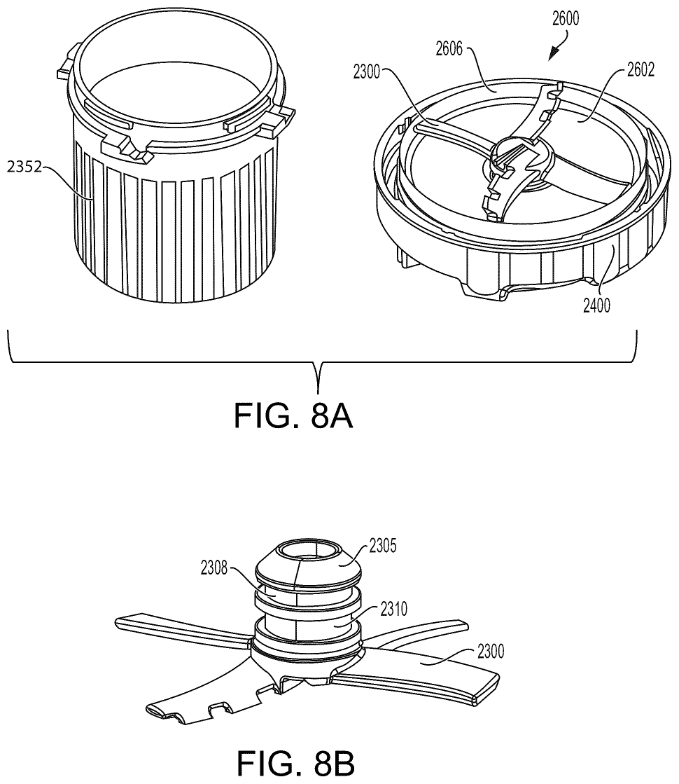

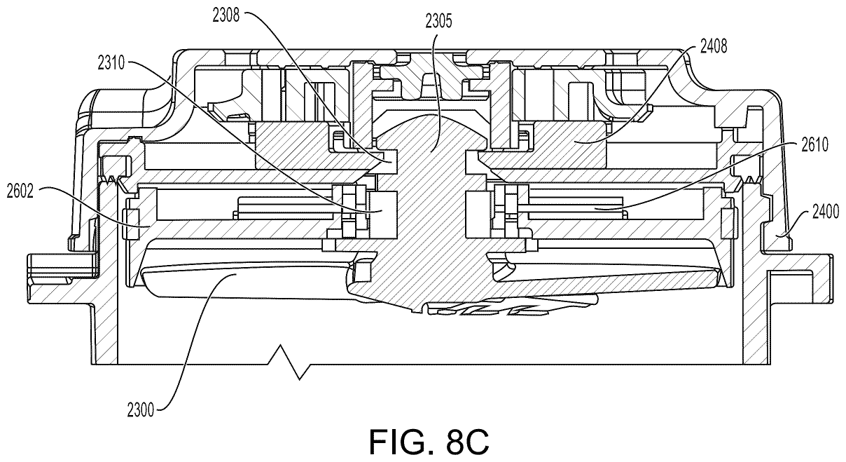

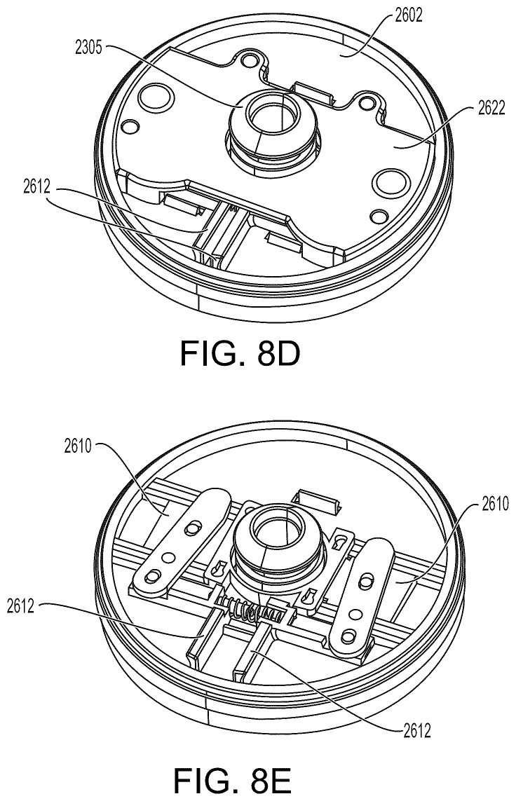

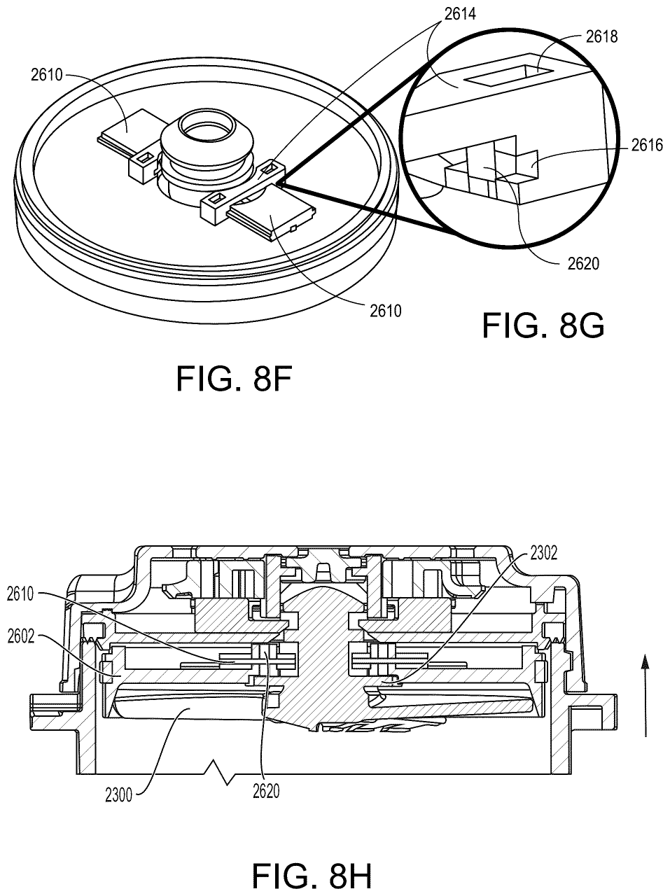

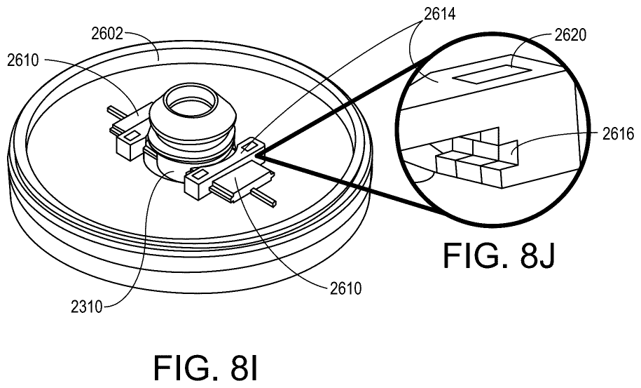

FIGS. 8A-8C illustrate another extrusion assembly 2600 in which the plunger 2602 and the blade 2300 may be installed to the same lid 2400, according to some embodiments of the disclosure. As shown in FIG. 8A, a plunger 2602, alone or in combination with other components (e.g., a lid 2400, a bowl 2352, and a nozzle), may constitute the extrusion assembly 2600 for extruding processed ingredients from the bowl 2352. In some embodiments, the bowl 2352 may be the bowl 352 including the centrally located opening 604 alignable with nozzle 608 (FIG. 4C). In other embodiments, the bowl 2352 may be the bowl 352′ including the nozzle 608″ that is integrated with the bottom edge of the bowl 352′ (FIG. 4G). A user may assemble the extrusion assembly 2600 in a similar manner to the extrusion assembly 1600 of FIGS. 7A-7D. For example, the plunger 2602 may be magnetically or otherwise couplable to an underside of the lid 2400. Once the plunger 2602 has been installed on the lid 2400, a user may couple the blade 2300 to an underside of the plunger 2602 such that the blade 2300 is housed within a circumferential wall 2606 of the plunger 2602. As shown in FIG. 8B, the central support hub 2305 of the blade 2300 may include an upper groove 2308 and a lower groove 2310. As shown in FIG. 8C, the lid 2400 may include a first set of engagement features, such as primary clips 2408, that are biased (e.g., spring biased) toward the central support hub 2305. As the user installs the blade 2300 to the lid 2400, the primary clips 2408 may engage the upper groove 2308 of the central support hub 2305. In this configuration, a second set of engagement features on the plunger 2602, such as secondary clips 2610, are disengaged from the lower groove 2310 such that the blade 2300 can be driven axially and rotationally by the driven shaft 250 independent of the plunger 2602.

FIGS. 8D-8I illustrate the configuration and movement of the secondary clips 2610 according to some embodiments of the disclosure. As shown in FIG. 8D, an upper surface of the plunger 2602 may comprise a set of moveable levers 2612 disposed within a housing 2622 that is configured to allow for passage of the central support hub 2305. As shown in FIG. 8E, the levers 2612 may be operatively coupled to the secondary clips 2610 such that the levers 2612 are positioned apart when the secondary clips 2610 are engaged with the lower groove 2310. As shown in FIG. 8F, the secondary clips 2610 may be moveable through opposing bridge members 2614 on the upper surface of the plunger 2602, as shown in more detail in FIG. 8G. An inner surface of the bridge members 2614 may define opposing slots 2616. The bridge members 2614 may further define channels 2618 for passage of blocking members 2620. While the blade 2300 is processing ingredients within the bowl 2352, the blocking members 2020 may block the slots 2616 such that the secondary clips 2610 are prevented from moving through the bridge members 2614 and engaging the lower groove 2310, thus preventing the plunger 2602 from engaging the driven shaft 2250. As shown in FIG. 8H, to engage the plunger 2602 to the central support hub 2305 during the extrusion phase, the blade 2300 may move slightly upward such that a platform 2302 on the blade 2300 causes the blocking members 2020 to move upwards through the channels 2618, thus unblocking the slots 2616. As shown in FIGS. 8I and 8J, once the blocking members 2620 no longer block the slots 2616, the secondary clips 2610 may move through the bridge members 2614 to engage the lower groove 2310. In this configuration, both the blade 2300 and plunger 2602 are operatively engaged with the driven shaft 250 such that both the blade 2300 and the plunger 2602 can be descended through the bowl 2352 to extrude the processed ingredients from the bowl 2352.

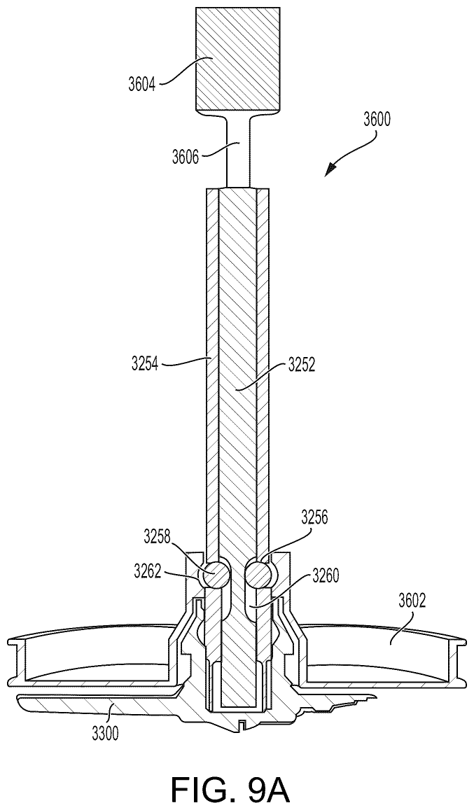

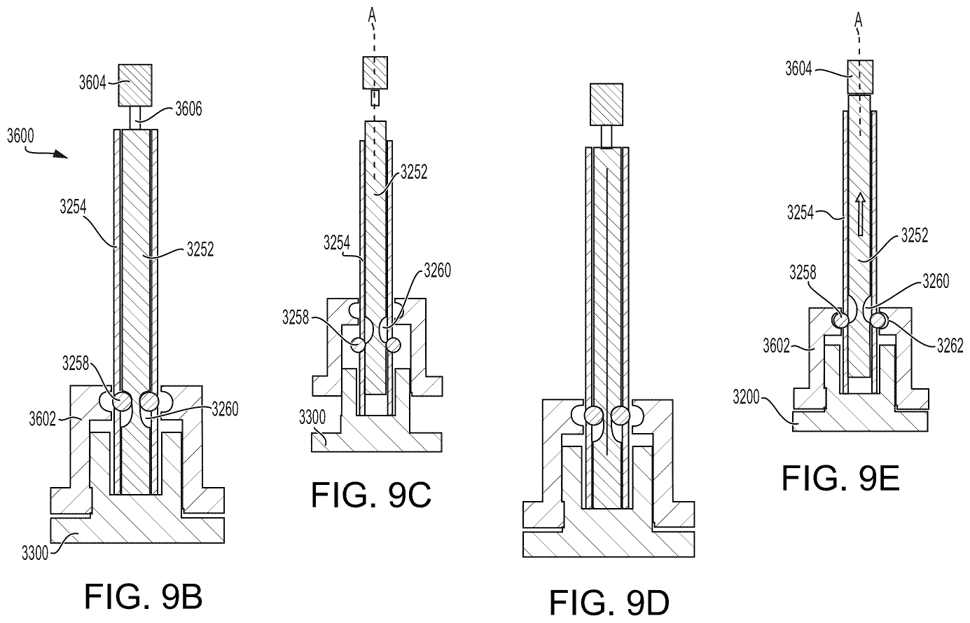

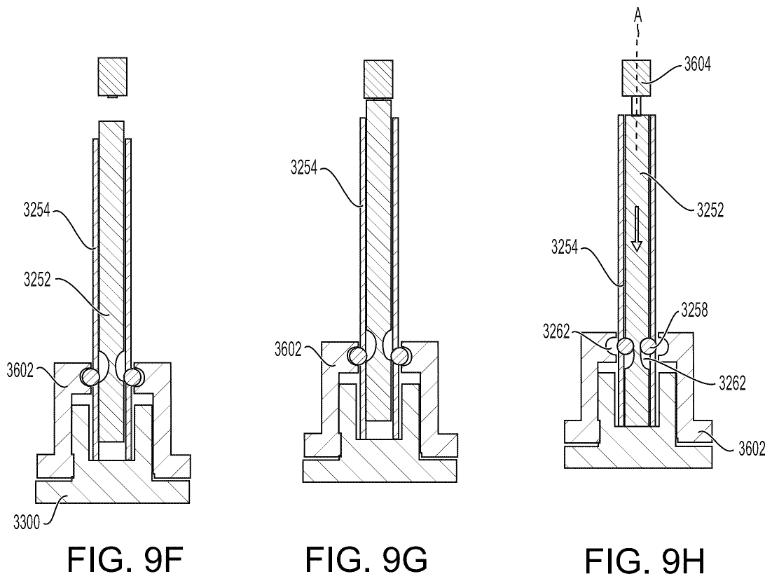

FIG. 9A illustrates another extrusion assembly 3600 in which the plunger 3602 and the blade 3300 may be installed to the same lid, according to some embodiments of the disclosure. As shown in FIG. 9A, a plunger 3602, alone or in combination with other components (e.g., a lid, a bowl, and a nozzle, not shown), may constitute the extrusion assembly 3600 for extruding processed ingredients from the bowl. In some embodiments, the bowl may be the bowl 352 including the centrally located opening 604 alignable with nozzle 608 (FIG. 4C). In other embodiments, the bowl may be the bowl 352′ including the nozzle 608″ that is integrated with the bottom edge of the bowl 352′ (FIG. 4G). The extrusion assembly 3600 may comprise an electromagnet, such as a solenoid 3604, operable with a piston configured to move an inner shaft 3252. The inner shaft 3252 may extend through an outer shaft 3254 such that the inner shaft 3252 and the outer shaft 3254 can translate independently of each other. The outer shaft 3254 may define opposing holes 3256 for passage of ball bearings 3258. An outer surface of the inner shaft 3252 may define opposing cavities 3260 for housing the ball bearings 3258. An inner surface of the plunger 3602 also may define opposing recesses 3262 for receiving the ball bearings 3258. The blade 3300 may be attachable to the outer shaft 3254, for example, by a bayonet coupling. However, the disclosure contemplates other suitable methods for coupling the blade 3300 to the outer shaft 3254.

FIGS. 9B-9H schematically illustrate the use of the extrusion assembly 3600 according to some embodiments of the disclosure. As shown in FIG. 9B, the user may first install the plunger 3260 to the lid (not shown), for example, via a magnetic coupling. In this configuration, the plunger 3206 may not be attached to the outer shaft 3254 and the ball bearings 3258 may reside in an upper portion of the cavities 3260 of the inner shaft 3252. The user may then attach the blade 3300 to the outer shaft 3254. As shown in FIG. 9C, to begin the processing step, the outer shaft 3254, together with the ball bearings 3258, may translate relative to the inner shaft 3252 to descend the blade 3300 into the bowl and then rotate with the inner shaft 3252 to process the ingredients within the bowl. As the ball bearings 3258 travel along the inner surface of the cavities 3260 to the end of the lower portion of the cavities 3260, they may move away from the central axis A to protrude from the holes 3256 in the outer shaft 3254. As shown in FIG. 9D, once the processing step is complete, the components may return to the home position shown in FIG. 9B. As shown in FIG. 9E, to begin the extrusion step, the solenoid 3604 may retract, causing the inner shaft 3252 to move upwards relative to the outer shaft 3254. As the ball bearings 3258 reach the end of the lower portion of the cavity 3260, they may again move away from the central axis A to protrude from the holes 3256 in the outer shaft 3254 and thus engage the recesses 3262 in the plunger 3602. In this configuration, the plunger 3602 may be locked to the outer shaft 3254. As shown in FIG. 9F, both the inner shaft 3252 and the outer shaft 3254 may descend again with both the plunger 3602 and the blade 3300 attached to extrude the processed ingredients from the nozzle. As shown in FIG. 9G, once the extrusion step is complete, the components may return to the pre-extrusion position shown in FIG. 9E, with the plunger 3602 still attached to the outer shaft 3254. Finally, as shown in FIG. 9H, the solenoid 3604 may extend, causing the inner shaft 3252 to move downward to relative to the outer shaft 3254. As the ball bearings 3258 reach the upper portion of the cavity 3260, they may move toward the central axis A to disengage from the recesses 3262 in the plunger 3602. In this configuration, the plunger 3602 may be disconnected from the outer shaft 3254.

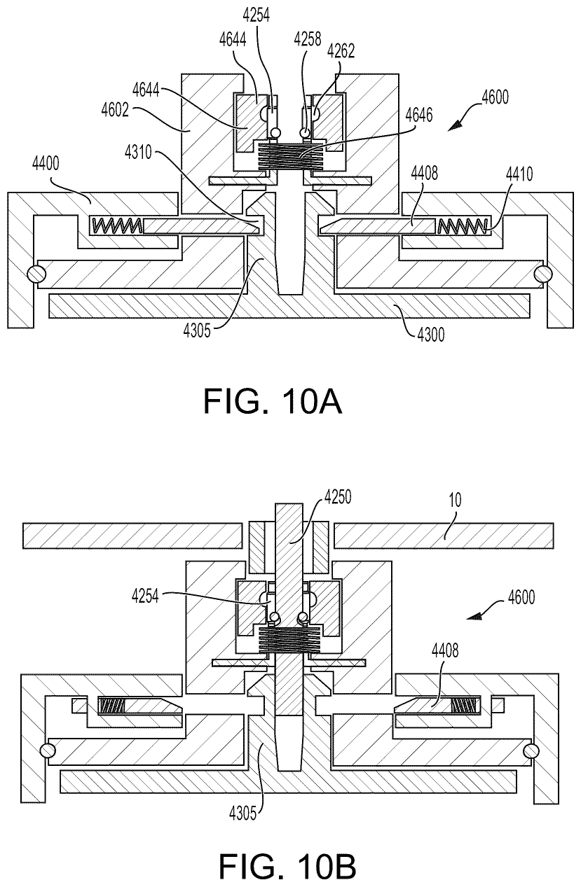

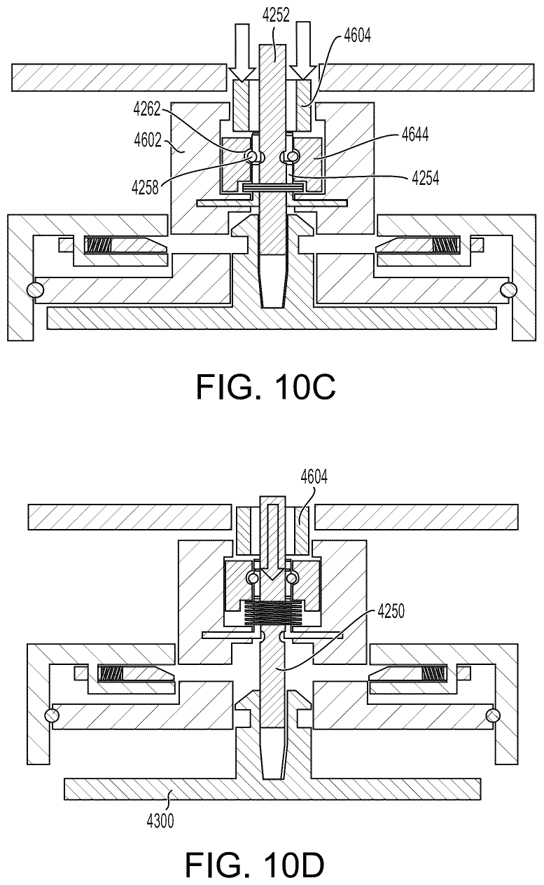

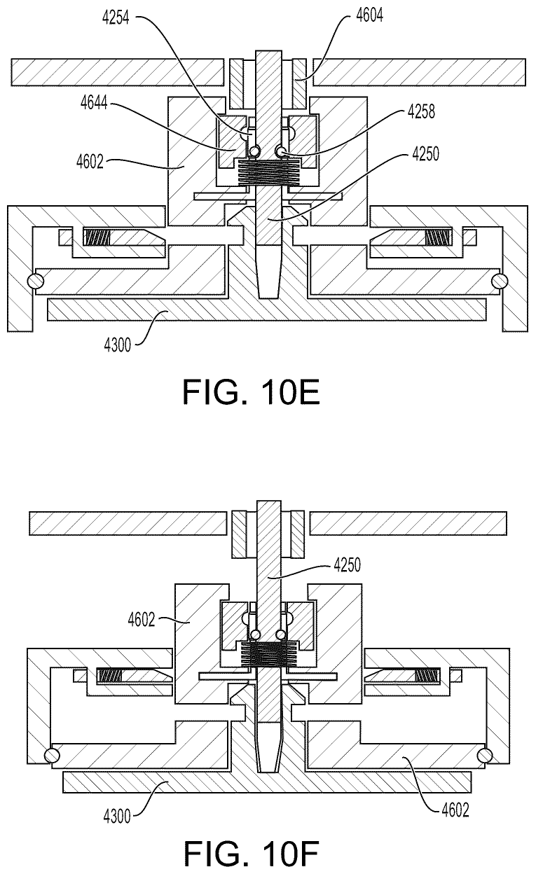

FIGS. 10A-10F schematically illustrate the use of another extrusion assembly 4600 according to some embodiments of the disclosure. As shown in FIG. 10A, a plunger 4602, alone or in combination with other components (e.g., a lid 4400, a bowl, and a nozzle), may constitute the extrusion assembly 4600 for extruding processed ingredients from the bowl. In some embodiments, the bowl may be the bowl 352 including the centrally located opening 604 alignable with nozzle 608 (FIG. 4C). In other embodiments, the bowl may be the bowl 352′ including the nozzle 608″ that is integrated with the bottom edge of the bowl 352′ (FIG. 4G). As shown in FIG. 10A, the extrusion assembly 4600 may further comprise an outer shaft 4254 extending through the plunger 4602. An inner surface of the outer shaft 4254 may be configured to house ball bearings 4258. A moveable collar 4644 may be disposed about the outer shaft 4254 and may be biased upward, for example, by a first spring 4646. To begin the processing step, the user may first install the plunger 4602 to the lid 4400. The user may then attach the blade 4300 to the lid 4400 such that a pair of primary clips 4408 act under force of a second spring 4410 to engage a groove 4310 on the central support hub 4305. As shown in FIG. 10B, the user may then attach the lid 4400 to the bowl (not shown) and couple to the bowl to the micro-puree machine 10 such that the driven shaft 4250 extends through the outer shaft 4254 to engage the central support hub 4305. The micro-puree machine 10 may be configured such that coupling the bowl to the micro-puree machine 10, 800 causes the primary clips 4408 to disengage from the central support hub 4305 to allow the blade 4300 to move away from the lid 4400. As shown in FIG. 10C, to begin the processing step, an electromagnet, such a solenoid 4604, may press down on the collar 4644 to move the collar 4644 against the force of the spring 4646 such that ball bearings 4258 extend through openings in the outer shaft 4254 to engage recesses 4262 on an inner surface of the collar 4644. In this configuration, the plunger 4602 may be locked to the outer shaft 4254 such that the blade 4300 can move independently of the plunger 4602. As shown in FIG. 10D, the driven shaft 4250 and the blade 4300 may descend into the bowl and rotate to process ingredients within the bowl. As shown in FIG. 10E, after processing, the driven shaft 4250 and the blade 4300 may then return to the home position. To begin the extrusion step, the solenoid 4604 may no longer press down on the collar 4644, allowing the collar 4644 to move upward to release the ball bearings 4258 from engagement with the collar 4644 such that the plunger 4602 is no longer locked to the outer shaft 4254. Finally, as shown in FIG. 10F, the driven shaft 4250 may descend both the plunger 4602 and the blade 4300 into the bowl to extrude the processed ingredients from the bowl.

The disclosed micro puree machine may include a plunger drive inhibitor and/or

decoupler to reduce the amount of force that can be applied to various components of the extrusion assembly. As previously described, the extrusion assembly may include a lever (e.g., 5730, 830 or any other lever described herein) that can be manipulated by a user to extrude contents within the bowl 852 using a plunger 802 (or any other plunger described herein, such as plunger 602, 1602, 2602, 3602, and/or 4602). Movement of the plunger is controlled by a drive train. If the contents within the bowl 852 are too hard, damage can occur when extruding or attempting to extrude the contents of the bowl. To protect the drive train and other componentry of the extrusion assembly, a plunger drive inhibitor and/or decoupler may be used to selectively restrict or eliminate input force applied to the lever from transferring to the extrusion drive train (and activating the plunger 802) if a level of force above a predetermined force limit and/or threshold is detected. The disclosed plunger drive inhibitor may be used in connection with any extrusion assembly described herein, including extrusion assemblies 600, 1600, 2600, 3600, and/or 4600. Limiting the amount of force that can be exerted on the drive train can advantageously prevent damage and extend lifetime of the drive train and other components of the extrusion assembly.

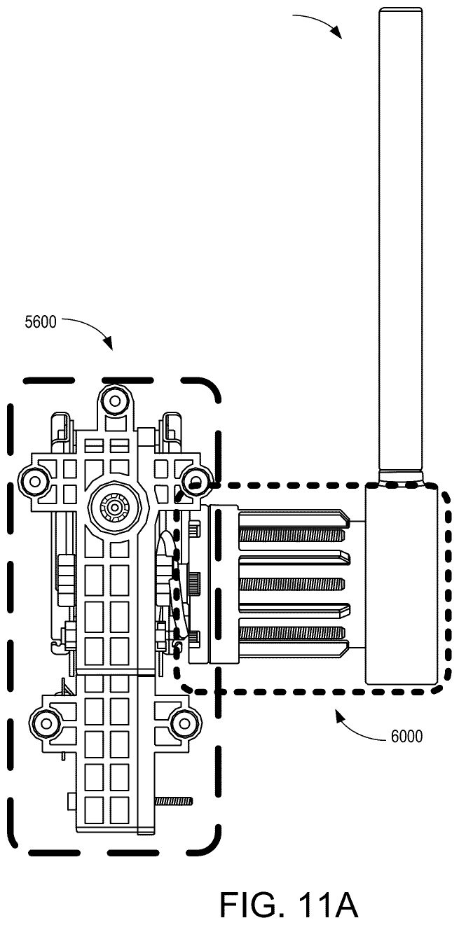

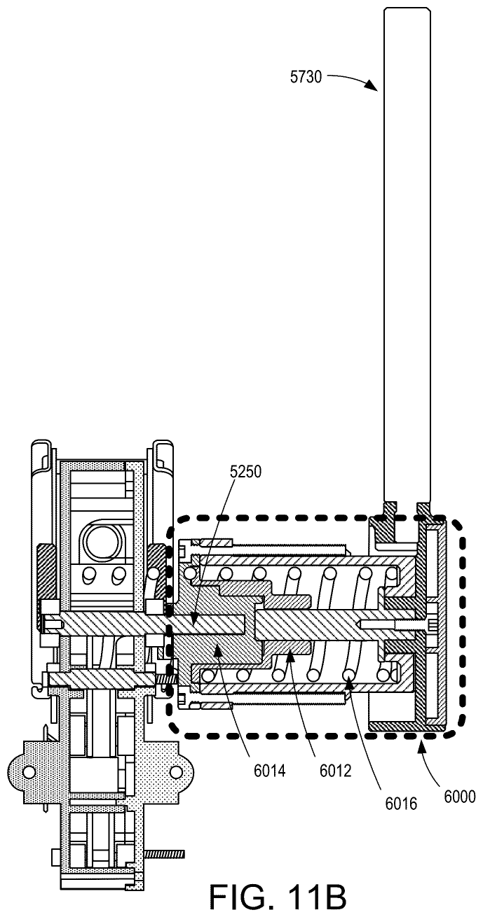

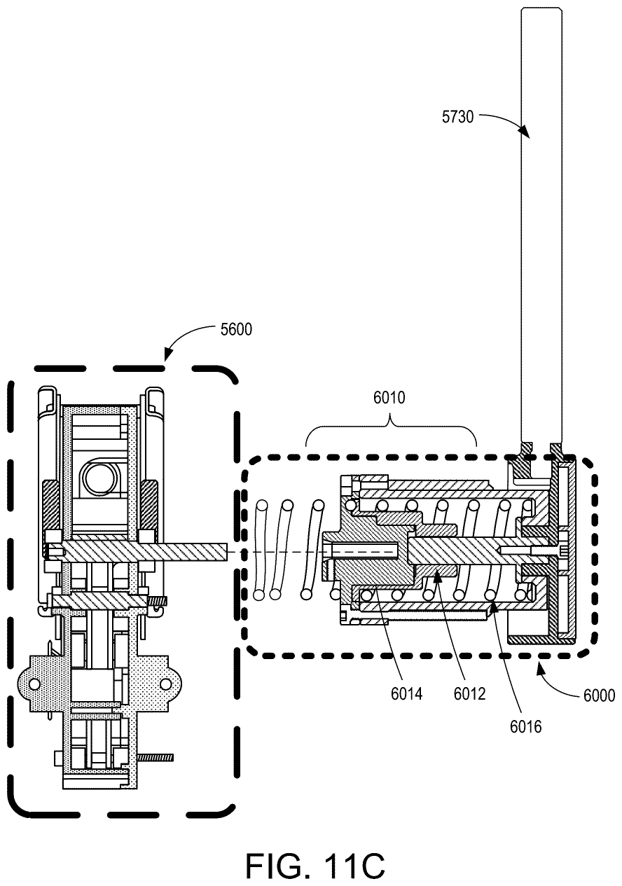

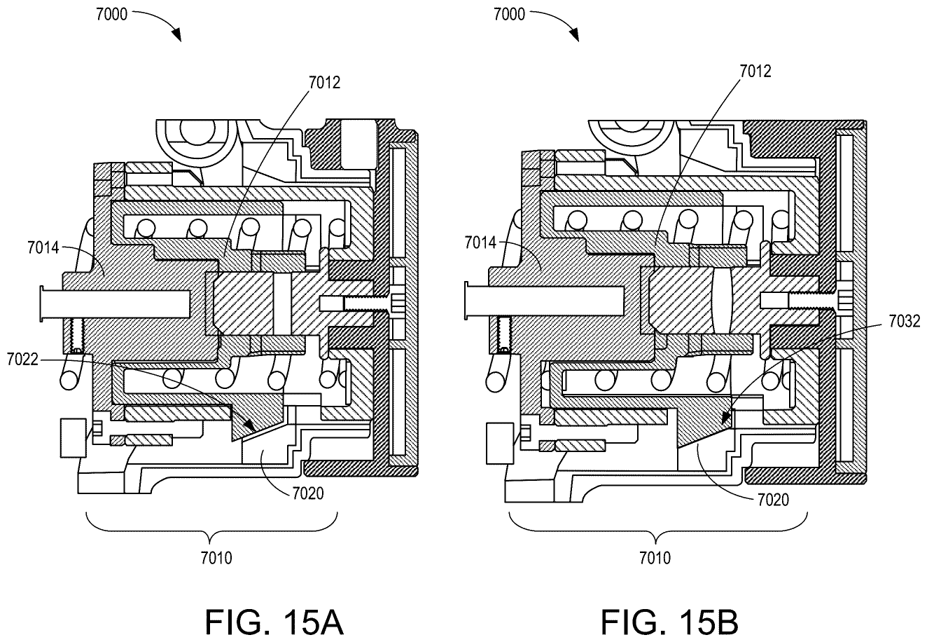

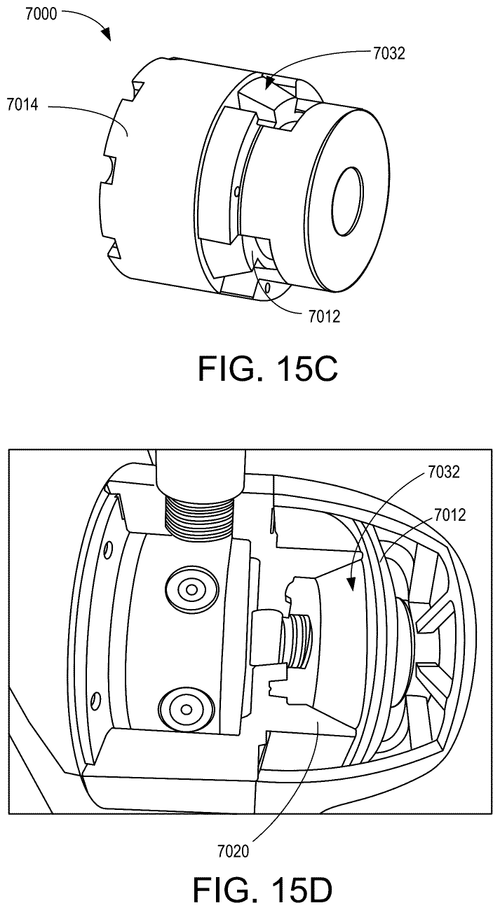

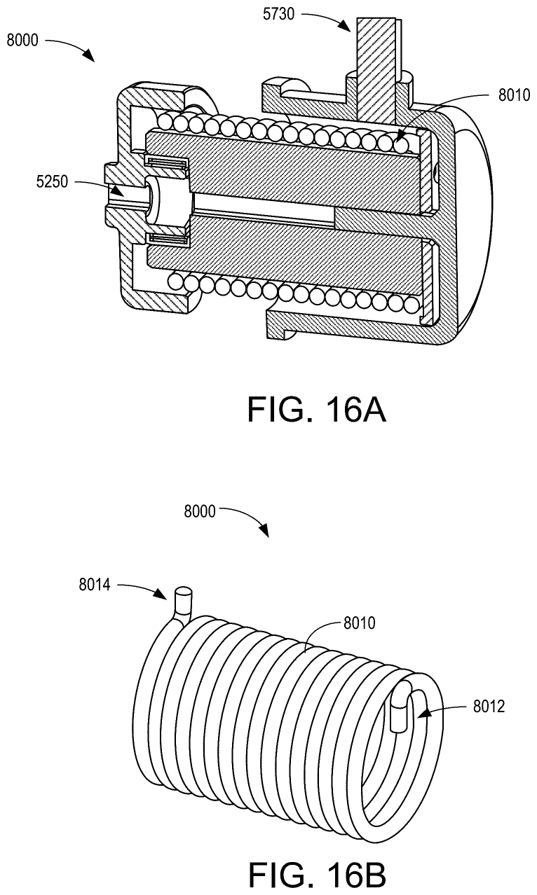

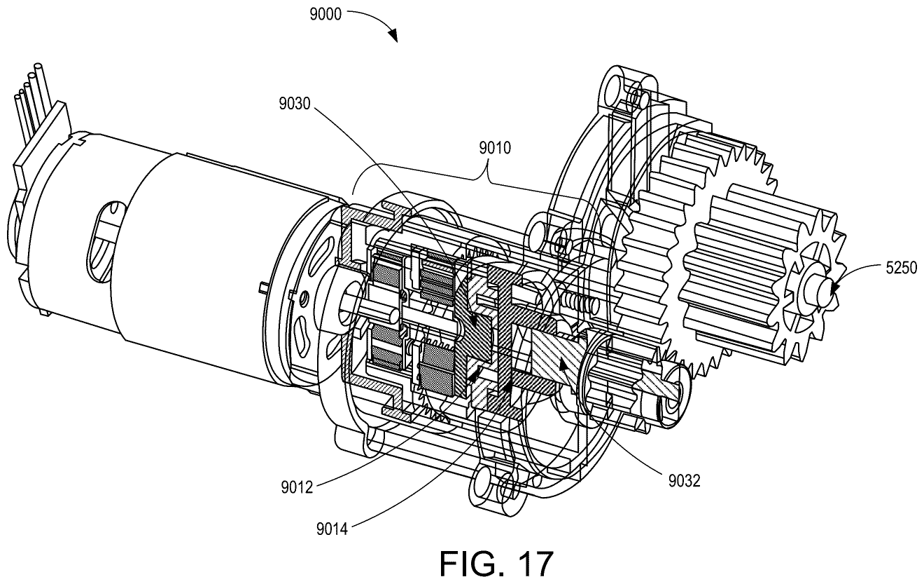

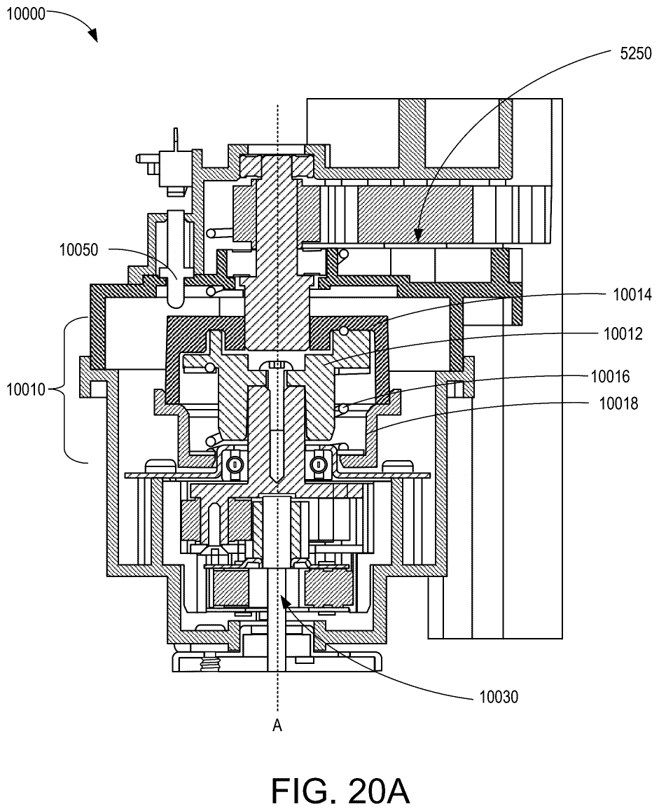

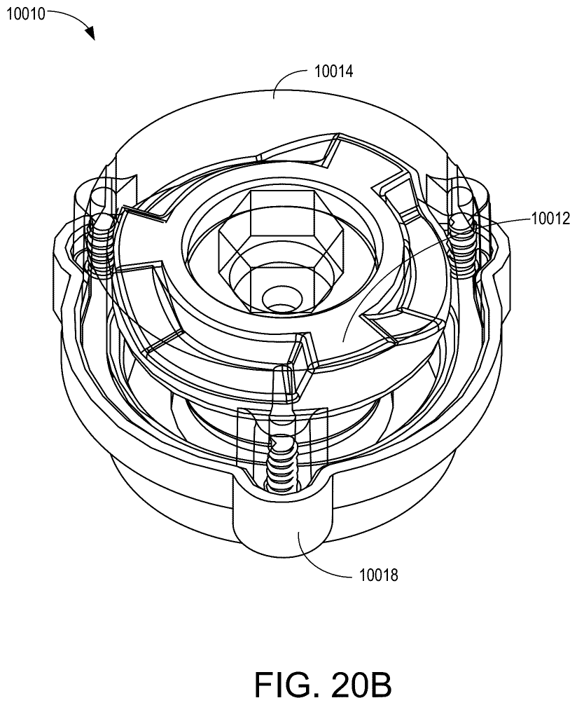

The plunger drive inhibitor and/or decoupler may be implemented using various mechanical and/or electrical mechanisms. For example, the plunger drive inhibitor may be configured to mechanically divert force applied to the lever from the extrusion drive train if a force limit and/or threshold is exceeded. In alternative implementations, an electrical mechanism may be used to cut power to the motor of the extrusion assembly if a force limit and/or threshold is exceeded. Various different implementations of the disclosed plunger drive inhibitor and/or decoupler are possible and discussed below in detail. Specifically, FIGS. 11A-14 illustrate a plunger drive inhibitor 6000 that includes a slip clutch assembly, FIGS. 15A-15C illustrate a plunger drive inhibitor 7000 with a slip clutch assembly and a frictional cone brake, FIGS. 16A-16B illustrate a plunger drive inhibitor 8000 implemented with a torsion spring, FIGS. 17-19 illustrate a plunger drive inhibitor 9000 having an automated slip clutch assembly with a sensor configured to switch off the extrusion assembly when slipping of the clutch plates is electrically detected, and FIGS. 20A-20B illustrate a plunger drive inhibitor 10000 having an automated and self-contained slip clutch assembly. Details of each of these plunger drive inhibitors are described below in detail.

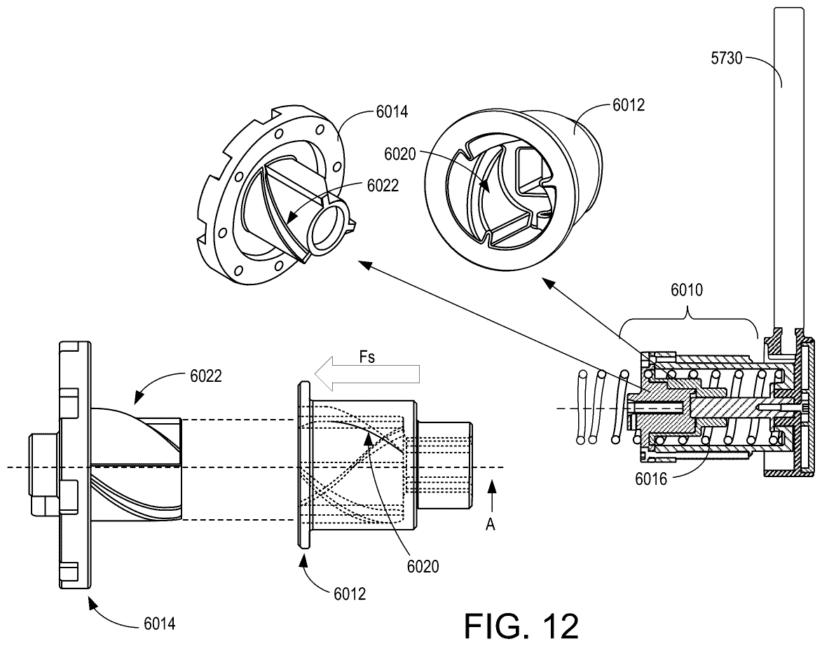

FIGS. 11A-11C illustrate a plunger drive inhibitor and/or decoupler 6000. The plunger drive inhibitor 6000 is connected to lever 5730 and extrusion assembly 5600. The extrusion assembly 5600 has an input shaft 5250 that drives the plunger of the extruder (not shown). Plunger drive inhibitor 6000 includes a slip clutch assembly 6010 with two clutch plates, namely a first clutch plate 6012 (i.e., a “driving” clutch plate) and a second clutch plate 6014 (i.e., a “driven” clutch plate). Features of the first clutch plate 6012 and the second clutch plate 6014 are further illustrated in FIG. 12. The first clutch plate 6012 is configured to rotate when the lever 5730 is turned, and the second clutch plate 6014 is configured to drive rotation of the extruder input shaft 5250. A spring 6016 within the slip clutch assembly 6010 exerts a spring force (Fs) on the first clutch plate 6012 to maintain contact with the second clutch plate 6014. The spring force (Fs) is parallel to the central axis (A) of the slip clutch assembly 6010. During use, the first clutch plate 6012 rotates with the second clutch plate 6014 until a level of force above a predetermined force limit and/or threshold is reached or exceeded.

The first clutch plate 6012 includes a first surface 6020 positioned to contact a second surface 6022 of the second clutch plate 6014. First surface 6020 and second surface 6022 are each angled with respect to a plane that intersects the central axis (A) of the slip clutch assembly 6010. First surface 6020 and second surface 6022 are pressed together by the spring force (Fs) applied by the spring 6016, resulting in friction at the boundary of the first surface 6020 and the second surface 6022. When contact is maintained between the first surface 6020 and the second surface 6022, the second clutch plate 6014 rotates with the first clutch plate 6012 (i.e., the rotational force applied from the lever 5730 is fully transferred from the first clutch plate 6012 to the second clutch plate 6014).

The slip clutch assembly 6010 is arranged such that the first surface 6020 and the second surface 6022 have enough engagement with each other to allow the lever 5730 to move through its full range of motion (from the home position to the fully open position) without fully disengaging one another. When slipping, the first clutch plate 6012 rotates with respect to the second clutch plate 6014, resulting in no input being transferred to the extruder input shaft 5250. Conversely, when not slipping, the first clutch plate 6012 does not rotate with respect to the second clutch plate 6014, and rotation is delivered to the extruder input shaft 5250. The slip clutch assembly 6010 is configured to slip if a level of force to move the plunger exceeds a predetermined safe limit and/or threshold. In embodiments in which input torque exerted on lever 5730 is transferred directly to the extruder input shaft 5250, the amount of force to move the plunger may be approximately equal to the amount of force applied to the lever 5730. Thus, in some such embodiments, the slip clutch assembly 6010 may be configured to slip if a level of force applied to the lever 5730 is above a predetermined limit and/or threshold.

If the force required to rotate the second clutch plate 6014 plate is higher than the torque to overcome the friction between the two clutch plates, the first clutch plate 6012 is permitted to rotate with respect to the second clutch plate 6014. This rotation, once friction is overcome, causes the first surface 6020 and the second surface 6022 to slide along one another, translating the first clutch plate 6012 along the central axis (A). This relative motion between the first surface 6020 and the second surface 6022 prevents rotation of the first clutch plate 6012 from being transferred to the second clutch plate 6014.

The first surface 6020 and the second surface 6022 may be formed to have any desired meshing configuration. For example, in some implementations, the first surface 6020 and the second surface 6022 may be helically shaped around the central axis (A) of the slip clutch assembly 6010. In some implementations, as shown in FIG. 12, the first clutch plate 6012 and the second clutch plate 6014 may each include three helical surfaces positioned equidistantly around the central axis (A). However, the first clutch plate 6012 and the second clutch plate 6014 may each include any desired number of angled surfaces. For example, the first clutch plate 6012 and the second clutch plate 6014 may each include one, two, three, four, five, or more angled surfaces. If the first clutch plate 6012 and the second clutch plate 6014 each include more than one angled surface, the first angled surfaces need not have the same angle as the second angled surfaces. To increase torque at the slip, steeper angled surfaces may be used, the coefficient of friction for the clutch plates may be increased, and/or a spring 6016 that exerts a higher spring force (Fs) may be used.

The slip clutch assembly 6010 may be configured such that the first surface 6020 and the second surface 6022 never fully disengage, even if the clutch slips or binds. In some such implementations, the lever 5730 maintains alignment to the plunger that the slip clutch assembly 6010 drives. Thus, even if the slip clutch assembly 6010 slips and then reengages, the lever 5730 will be positioned in the correct position (i.e., with respect to the home position and the fully open position) to drive the plunger 602 at the desired level.

The slip clutch assembly 6010 limits the torque that can be applied to the extruder input shaft 5250 (i.e., the manual extrusion input shaft) to prevent damage to the mechanism, to the lever 5730 and to the extrusion opening/nozzle. Without the plunger drive inhibitor 6000, an infinite amount of torque could be transferred from the lever 5730 to the extruder input shaft 5250, to the point of part failure.

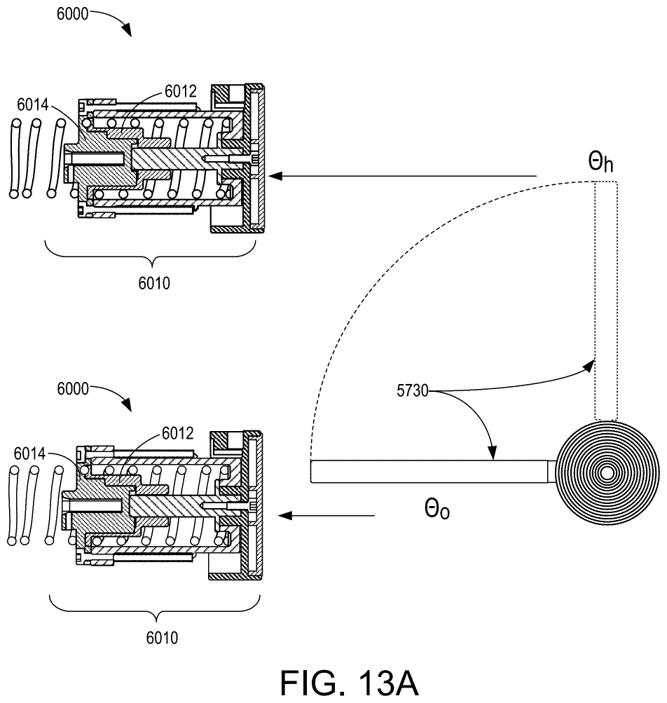

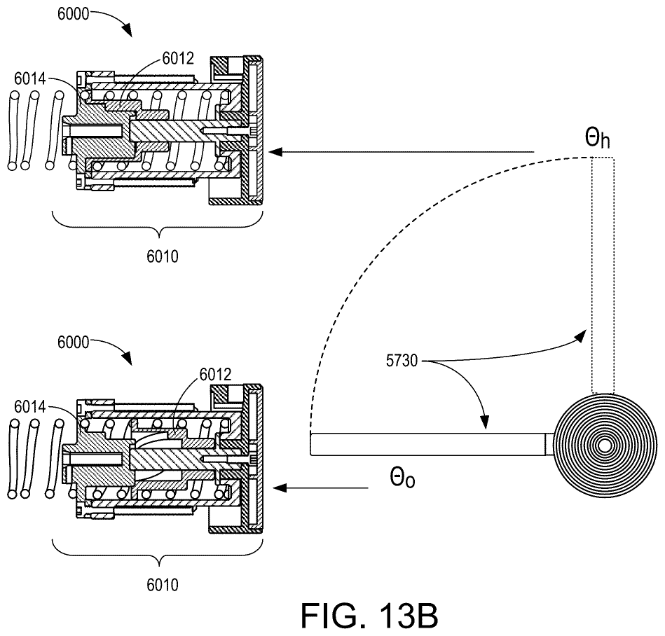

FIGS. 13A-13B illustrate cross-sectional views of the plunger drive inhibitor and/or decoupler 6000 as the lever 5730 moves between the home position (θₕ) and the fully open position (θₒ). In some implementations, the home position (θₕ) of the lever 5730 is vertical and the fully open position (θₒ) of the lever 5730 is horizontal. Movement of lever 5730 between the home position (θₒ) and the fully open position (θₒ) may be 90°, or in some cases, 180°. FIG. 13A shows a situation in which the slip clutch assembly 6010 is not slipping and FIG. 13B shows a situation in which the slip clutch assembly 6010 is slipping and/or the lever 5730 is decoupling from the extrusion assembly 5600. If the torque required to rotate the lever 5730 is less than the slip threshold of the slip clutch assembly 6010, both the first clutch plate 6012 and the second clutch plate 6014 will rotate together, as shown in FIG. 13A. During routine use conditions, the slip clutch assembly 6010 will transfer 100% of the torque applied to the lever 5730 to the extruder input shaft 5250. The lever 5730 can move from its home position (θₕ) to the fully open position (θₒ) when the slip clutch assembly 6010 does not slip.

If the torque required to rotate the lever 5730 exceeds the slip torque threshold of the slip clutch assembly 6010, the first surface 6020 (of the first clutch plate 6012) rotates relative to the second surface 6022 (of the second clutch plate 6014), causing the first clutch plate 6012 to translate along the central axis (A) and move away from and/or decouple from the second clutch plate 6014. Translation of the first clutch plate 6012 prevents rotation from being transferred from the lever 5730 to the manual extrusion input shaft 5250. FIG. 13B illustrates movement of the slip clutch assembly 6010 during slipping. During slipping of the slip clutch assembly 6010, the lever 5730 can be moved from the home position (θₕ) to its maximum open position (θₒ). Even during slipping, throughout all lever positions (between θₕ and θₒ), the first surface 6020 maintains contact with the second surface 6022. Other known slip clutch assemblies are configured to allow the clutch plates to fully disengage during slipping. However, the presently disclosed slip clutch assembly 6010 is, in some implementations, configured to maintain engagement between the first clutch plate 6012 and the second clutch plate 6014, even during slipping, to maintain system alignment. If the slip clutch assembly 6010 experiences slipping, a user may simply return the lever 5730 to the home position (θₕ), which allows the first clutch plate 6012 to return to increased contact with the second clutch plate 6014, and the user may then attempt to move the lever 5730 to the desired position.

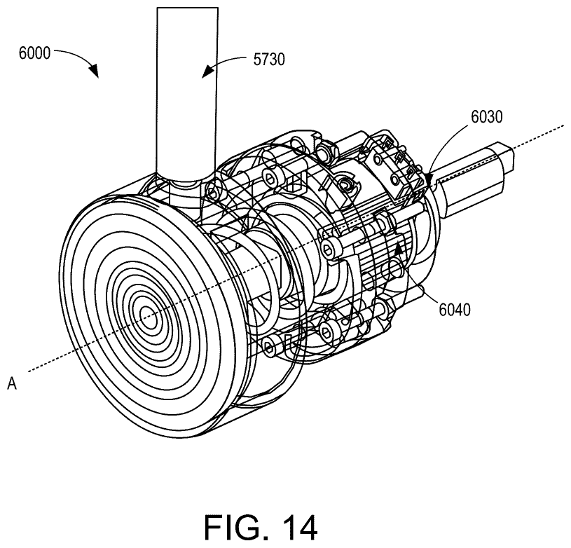

If desired, the plunger drive inhibitor 6000 may include features to signal to a user when the slip clutch assembly 6010 is slipping or decoupling the lever 5730 from the extrusion assembly 5600. For example, the plunger drive inhibitor 6000 may include haptic feedback, audio feedback, and/or visual feedback for a user. For example, the slip clutch assembly 6010 may include passive lever haptics to inform the user of slipping. Lever haptics may be achieved by using a sprung plunger against a rough surface 6040 to create vibration through the lever 5730 (with or without audible vibration) only during slip, as shown in FIG. 14. Passive haptic features in the slip clutch assembly 6010 can provide a cost-effective way to signal slipping of the plunger drive inhibitor 6000 without electrical elements. FIG. 14 illustrates a plunger drive inhibitor 6000 with a microswitch 6030 (or other type of electromechanical switch) positioned to be deactivated after 5-10 degrees of slip between the clutch plates. Specifically, the microswitch 6030 is positioned to be deactivated by translation and rotation of the first clutch plate 6012 along the central axis (A) during slipping. It should be appreciated that in alternative implementations, translation or rotation of the first clutch plate 6012 along the central axis (A) may be used to detect slipping. Detecting clutch slip can provide numerous advantages. For example, once clutch slip is detected, a user may be prompted to perform an action (e.g., to re-spin the bowl).

FIGS. 15A-15C illustrate a plunger drive inhibitor and/or decoupler 7000 with a slip clutch assembly 7010 that includes a frictional cone brake 7020. The slip clutch assembly 7010 may include any of the features described herein with respect to slip clutch assembly 6010. For example, the slip clutch assembly may include a first clutch plate 7012 and a second clutch plate 7014. If the slip clutch assembly 7010 slips, the first clutch plate 7012 translates, due to the contacting surfaces of the clutch plates. This translation results in the first clutch plate 7012 engaging with frictional cone brake 7020. FIG. 15A illustrates the slip clutch assembly 7010 without slipping and FIG. 15B illustrates the slip clutch assembly 7010 during slipping. The frictional cone brake 7020 includes a conical surface 7030 shaped to engage a

conical surface 7032 of the first clutch plate 7012. The frictional cone brake 7020 is positioned to prevent rotation of the first clutch plate 7012 after slip. The frictional cone brake 7020 only contacts the first clutch plate 7012 during slip. In alternative implementations, splines or other keying geometry may be used to restrict translational movement of the first clutch plate 7012.

Frictional cone brake 7020 also prevents lever 5730 from traveling through its full range of motion during clutch slip. Upon clutch slipping due to the lever torque threshold being exceeded, the angle range of lever 5730 may be limited. An advantage of using a frictional cone brake 7020 in connection with slip clutch assembly 7010 is that once the first clutch plate 7012 engages the frictional cone brake 7020, the lever 5730 cannot be moved from the position at which slip was detected toward the fully open position (θₒ). At the position when slip is detected, the lever 5730 delivers a jolt to the user. The jolt occurs due to a higher torque required to break friction than to maintain motion.

FIG. 16A illustrates a cross-sectional view of a plunger drive inhibitor and/or decoupler 8000 implemented with a torsion spring 8010. FIG. 16B illustrates a detailed view of the torsion spring 8010. The torsion spring 8010 includes a first end 8012 connected to lever 5730 and an opposed second end 8014 connected to the input shaft 5250 of the extrusion drive train. The torsion spring 8010 is preloaded with a defined torque (Tₚ) that will determine the torque threshold at which force exerted on the first end 8012 of the torsion spring 8010 is not transferred to the extruder input shaft 5250 at the second end 8014 of the torsion spring 8010. If the torque applied to the lever 5730 is greater than the preloaded torque (Tₚ) of the torsion spring 8010, the lever 5730 will cause the torsion spring 8010 to coil up (i.e., to experience non-permanent spring deformation) and no rotation from the lever 5730 will be transferred to the extruder input shaft 5250. Spring deformation resulting in lack of force transfer to the extruder input shaft 5250 can be referred to as “slipping.” The lever 5730 may be permitted to rotate through its full range of motion (between θₕ and θₒ), even during slipping, if desired. However, in other implementations, the movement of the lever 5730 may be restricted during slipping. Various slip detection features, such as haptics and/or electrical detection mechanisms can be incorporated into a plunger drive inhibitor 8000 having a torsion spring 8010. In addition to other possible advantages, using a torsion spring 8010 allows the threshold torque level at which slipping begins to be easily defined based on the preloaded torque (Tₚ) of the torsion spring 8010.

FIG. 17 illustrates a plunger drive inhibitor and/or decoupler 9000 having an automated slip clutch assembly 9010. In the automated slip clutch assembly 9010, a sensor is configured to switch off the extrusion assembly when a force limit and/or threshold has been reached or exceeded. The automated slip clutch assembly can have any features discussed herein with respect to slip clutch assembly 6010 or any other slip clutch assembly described herein. The automated slip clutch assembly 9010 may be positioned in the automated gear train between the input and the output (e.g., between the planetary gearset and the spur gears), as desired. The automated slip clutch assembly 9010 includes a first clutch plate 9012, a second clutch plate 9014, an input shaft 9030 attached to the first clutch plate 9012, and an output shaft 9032 attached to the second clutch plate 9014. As shown in FIG. 17, the output shaft 9032 may be positioned to deliver rotational force to the extruder input shaft 5250 (or to a dead shaft on which a gear is free to rotate and output usable torque). When there is no slipping, the slip clutch assembly 9010 receives an input rotation through the input shaft 9030 and outputs rotation through the output shaft 9032. Rotation from the lever 5730 is transferred to the input shaft 9030 of the slip clutch assembly 9010. The output shaft 9032 of the automated slip clutch assembly 9010 outputs rotation to the input shaft 5250 of the extrusion plunger. The output shaft 9032 only rotates if the input torque on the input shaft 9030 is below a designated level (i.e., below a designated slip threshold).

The automated slip clutch assembly 9010 includes a first clutch plate 9012 and a second clutch plate 9014 sprung into contact with one another. The first clutch plate 9012 includes a first surface in contact with a second surface of the second clutch plate 9014. The first surface and the second surface are each angled with respect to a plane that intersects the central axis of the automated slip clutch assembly 9010. The first surface and the second surface may be castellated or otherwise patterned to maintain a desired level of frictional contact between the first clutch plate 9012 and the second clutch plate 9014. When contact is maintained between the first surface and the second surface, the second clutch plate 9014 rotates with the first clutch plate 9012 (i.e., the rotational force applied from the lever 5730 is fully transferred from the first clutch plate 9012 to the second clutch plate 9014, which in turn transfers rotational force to the input shaft 5250 of the extrusion drive train). Numerous variables, such as friction at the boundary of the first surface and the second surface, the surface angle, and the spring force determine the slip threshold (i.e., the amount of force required to cause rotation of the first clutch plate 9012 relative to the second clutch plate 9014) of the automated slip clutch assembly 9010. If the force applied is below the slip threshold, the first clutch plate 9012 and the second clutch plate 9014 will rotate together without slipping. If the force applied is above the slip threshold, the first clutch plate 9012 will slip relative to the second clutch plate 9014, preventing the second clutch plate 9014 from rotating and, in turn, preventing the output shaft 9032 from rotating. As the clutch plates slip, the second clutch plate 9014 translates along a central axis of the automated slip clutch assembly 9010. (However, in alternative implementations, the first clutch plate 9012 may be configured to translate, and in other implementations, both the first clutch plate 9012 and the second clutch plate 9014 may each be configured to translate along the central axis).

Translation of the second clutch plate 9014 can be used to initiate contact with a microswitch or other electrical sensor to cut power to the extrusion motor if slipping is detected. In certain implementations, during normal operations, the plunger asserts about 300 lbs force on food items or ingredients while extending into the container 352 to facilitate extrusion and/or dispensing of the food items or ingredients from the container 352. If the plunger experiences resistance during extrusion, the force exerted by the plunger could exceed 1000 lbs force in about 0.7 seconds, resulting in a failure of the container 352 or container coupling. Slipping and/or decoupling, or partial decoupling of clutch plate 9012 with respect to clutch plate 9014 enables nearly immediate pressure relief and/or a pressure reduction to prevent excess force or pressure within the container 352 that could result in a failure of or damage to the container 352.

The automated slip clutch assembly 9010 may be activated by lever 5730, by a motor, or by a motorized lever, if desired. If a motor or a motorized lever is used to activate the automated slip clutch assembly 9010, the first clutch plate 9012 and the second clutch plate 9014 may be shaped to permit continuous slipping, since a motor has infinite acceptable positions relative to the drive train (as opposed to a manually-operated lever that is restricted to 90° of movement or another limited range of motion). In implementations in which a motor is used to activate the automated slip clutch assembly 9010, lever 5730 may serve to control extrusion speed (i.e., rotation of lever 5730 during extrusion may increase or decrease extrusion speed).

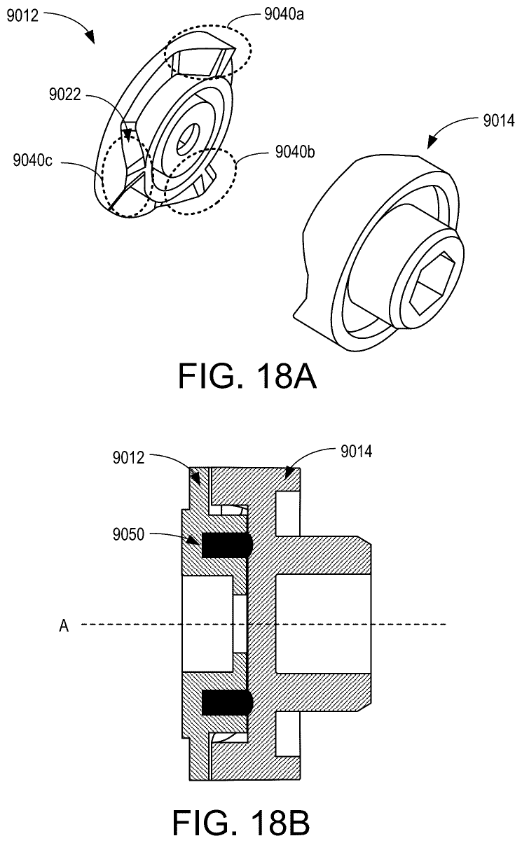

FIGS. 18A and 18B illustrate possible geometries for the first clutch plate 9012 and the second clutch plate 9014 of an automated slip clutch assembly (e.g., automated slip clutch assembly 9010 or an alternative automated slip clutch assembly). The first clutch plate 9012 may have any features described herewith with respect to first clutch plate 6012 and/or 7012. Similarly, the second clutch plate 9014 may have any features described herein with respect to second clutch plate 6014 and/or 7014.

As shown in FIGS. 18A and 18B, the first clutch plate 9012 includes a first surface 9020 angled with respect to a plane intersecting a central axis (A) of the automated slip clutch assembly. The second clutch plate 9014 includes a second surface 9022 angled with respect to a plane intersecting the central axis (A) of the automated slip clutch assembly 9010. The first surface 9020 and the second surface 9022 may be formed to have any desired meshing configuration.

The drive system of the automated slip clutch assembly 9010 may be omnidirectional, in that the extruder input shaft 5250 that controls movement of the plunger may be rotated in both a first direction and an opposed second direction. Omnidirectional rotation can allow the automated slip clutch assembly 9010 to extrude in a first direction (i.e., whereby the plunger forces contents within the bowl through the extrusion point) and to retract the plunger when operated in the reverse (second) direction. As will be appreciated upon consideration of the present disclosure, limiting the amount of torque applied to the assembly 9010 may only be required during extrusion, since the force needed to extrude certain ingredients may be highly variable. In contrast, the force required to retract the plunger may be more predictable due to fewer variables impacting retraction of the plunger.

The automated slip clutch assembly 9010 may be configured to rotate in a first rotational direction (e.g., anticlockwise) and in a second opposed rotational direction (e.g., clockwise). When rotating in a first rotational direction, the automated slip clutch assembly 9010 moves the plunger in a first axial direction to extrude ingredients (i.e., force ingredients in the bowl through the nozzle). When rotating in a second rotational direction, the automated slip clutch assembly 9010 moves the plunger in a second axial direction to retract the plunger within the bowl. Features on a user interface of the micro puree device may be used to select whether the automated slip clutch assembly 9010 rotates in a first rotational direction to extrude or in a second rotational direction to retract.

The first clutch plate 9012 and the second clutch plate 9014 may be shaped to facilitate omnidirectional rotational movement. In particular, the first clutch plate 9012 and the second clutch plate 9014 may be shaped such that the plates may slip relative to one another when rotating in a first direction and when rotating in an opposed second direction. Since it may be advantageous to set the threshold force (i.e., the slip threshold) at different levels for each direction of rotation, the first clutch plate 9012 and the second clutch plate 9014 may be configured to provide for different threshold force levels at which the clutch plates will slip relative to one another. FIGS. 18A and 18B illustrate sample geometries of the first surface 9020 of the first clutch plate 9012 and the second surface 9022 of the second clutch plate 9014. As shown in FIGS. 18A and 18B, the first surface 9020 includes a plurality of castellations 9040a, 9040b, 9040c, each castellation 9040 being separated by a recessed region 9042. Each castellation 9040 is formed of two angled surfaces (i.e., a first helix and a second helix). It should be appreciated that although FIGS. 18A-18B illustrate a first clutch plate 9012 with three castellations (9040a, 9040b, 9040c), any desired number of castellations 9040 may be present. For example, one, two, three, four, five, six, or more castellations 9040 may be included on first surface 9020.

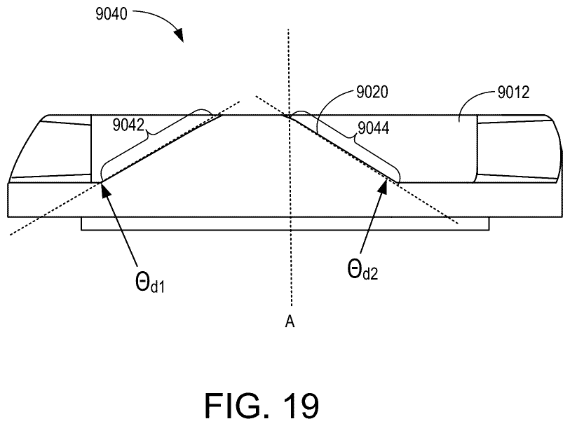

FIG. 19 illustrates a sample castellation 9040 for the first clutch plate 9012. As shown in FIG. 19, the first surface 9020 of the first clutch plate 9012 includes a castellation 9040 with a first angled portion 9042 and a second angled portion 9044. The first angled portion 9042 forms an angle (θ_{d1}) with a plane intersecting the central axis (A) and the second angled portion 9044 forms an angle (θ_{d2}) with a plane intersecting the central axis (A). θ_{d1} may be equal to or unequal to θ_{d12}. A steeper angle requires more torque to overcome the binding friction of the clutch plates. The angled portion that engages during extrusion may be shallower than the angled portion that engages during retraction, allowing the set torque limit for extrusion to be lower than the torque limit for retraction. Thus, in some implementations in which θ_{d1} is less than θ_{d2}, the first angled surface 9042 of castellation 9040 may be used for extrusion and the second angled surface 9044 may be used for retraction. The second surface 9022 of the second clutch plate 9014 may be shaped to engage the first surface 9020 of the first clutch plate 9012 around its entire circumference.

Wherein the clutch plates rotate with respect to one another, the automated slip clutch assembly 9010 is considered to be “slipping.” During slip, the castellations 9040 of the first clutch plate 9012 are continuously disengaging and reengaging with the second surface 9022 of the second clutch plate 9014 due to the continued rotation of the input shaft 9030. Slipping of the clutch plates can generate significant audible noise. Increasing the amount of space between castellations 9040 on the first surface 9020 of the first clutch plate 9012 can advantageously decrease audible noise by reducing the frequency that the clutch plates are able to re-engage, resulting in fewer audible clicks in the shut-off timeframe. Additionally, if desired, a cushion 9050 formed of an elastomeric or other rubber-like material may be used to dampen the impact force and sound generated by impacting features of the first clutch plate 9012 and the second clutch plate 9014 during slip. FIG. 18B illustrates a cushion 9050 affixed to the fist clutch plate 9012 and positioned to interface with the second surface 9022 of the second clutch plate 9014 during slipping.

FIGS. 20A-20B illustrate a plunger drive inhibitor 10000 with a self-contained automated slip clutch assembly 10010. The slip clutch assembly 10010 includes a first clutch plate 10012, a second clutch plate 10014, a spring plate 10018, and a spring 10016. One side of spring 10016 acts on the spring plate 10018 and the opposed side of spring 10016 acts on the first clutch plate 10012. The first clutch plate 10012 may have any features described herein with respect to first clutch plate 6012, 7012, and/or 9012. The second clutch plate may have any features described herein with respect to second clutch plate 6014, 7014, and/or 9014. Assembling the slip clutch assembly 10010 as shown in FIGS. 20A-20B may provide advantages over other configurations. For example, the spring 10016 acts on two plates, as opposed to a clutch plate and case work housing, as in other implementations. As a result, the slip clutch assembly 10010 may experience reduced wear since the spring 10016 rotates with both clutch plates during normal operation. Additionally, by fully encapsulating spring 10016, spring force is not transferred to any parts outside the self-contained slip clutch assembly 10010, thereby reducing wear to other components throughout the product's lifetime and improving predictability of the clutch slip torque.

As shown in FIG. 20B, the second clutch plate 10014 may be joined to the spring plate 10018 such that the first clutch plate 10012 and the spring 10016 are enclosed within a self- contained automated slip clutch assembly 10010. Assembling the slip clutch components as a self-contained assembly may provide numerous advantages as compared to other approaches. For example, the self-contained automatic slip clutch assembly 10010 may be independently tested and calibrated apart from other components on the production line, which should significantly reduce scrap rates. Additionally, the slip clutch components can be assembled in a controlled environment, apart from lubricants and other substances that could impact slip torque.

The slip clutch assembly 10010 may be configured to receive input torque from a motor 10030 or from a hand-activated lever (not illustrated). During normal use conditions, the first clutch plate 10012 rotates with the second clutch plate 10014 and the spring 10016. During slipping, the second clutch plate 10014 translates along a central axis (A) of the slip clutch assembly 10010 and contacts a microswitch 10050. Microswitch 10050 can provide a UL-certified path to shut off the extrusion motor for over-load protection. When slip is detected, the microswitch 10050 may send an electronic signal to an extrusion microcontroller, which adjusts power to the extrusion motor, causing extrusion to automatically cease when slipping is detected. Although FIG. 20A illustrates microswitch 10050 positioned to be activated when the clutch plates are slipping, in other implementations, microswitch 10050 may be positioned to constantly monitor the position of the second clutch plate 10014 and to send an electronic signal to the extrusion microcontroller when any variation from the normal position of the second clutch plate 10014 is detected.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

We claim:

1. An extrusion assembly for a micro puree machine comprising:
a bowl having an opening and at least one sidewall defining an interior volume;
a plunger engageable with a driven shaft configured to axially move the plunger within the interior volume of the bowl to cause ingredients within the interior volume to be extruded from the opening; and
a slip clutch configured to restrict axial movement of the plunger within the interior volume of the bowl when a predetermined force limit is reached or exceeded.

2. The extrusion assembly of claim 1, wherein the slip clutch has a first clutch plate and a second clutch plate configured to rotate together below the predetermined force limit and to rotate relative to one another above the predetermined force limit.

3. The extrusion assembly of claim 2, wherein the second clutch plate drives rotation of the driven shaft and, when above the predetermined force limit, rotational force is restricted from the driven shaft.

4. The extrusion assembly of claim 3, further comprising a motor arranged to drive rotation of the first clutch plate.

5. The extrusion assembly of claim 2, wherein the slip clutch further comprises a spring that exerts a spring force on the first clutch plate to maintain contact with the second clutch plate and the spring force is parallel to a central axis of the slip clutch.

6. The extrusion assembly of claim 2, wherein the first clutch plate comprises a first surface and the second clutch plate comprises a second surface, the first surface is in contact with the second surface, and the first surface and the second surface are each angled with respect to a plane intersecting a central axis of the slip clutch.

7. The extrusion assembly of claim 2, wherein above the predetermined force limit, the first clutch plate or the second clutch plate translates axially along a central axis of the slip clutch.

8. The extrusion assembly of claim 7, further comprising a microswitch to electrically monitor axial translation of the first clutch plate or the second clutch plate.

9. The extrusion assembly of claim 8, wherein the microswitch is configured to send an electrical signal to a microcontroller to stop rotation of the driven shaft if axial movement of the first clutch plate or the second clutch plate is detected.

10. The extrusion assembly of claim 2, further comprising a frictional cone brake having a conical surface shaped to engage a conical surface of the first clutch plate when the predetermined force limit is exceeded.

11. An automated slip clutch assembly for a micro puree machine, the automated slip clutch assembly comprising:
a first clutch plate;
a second clutch plate;
a spring positioned to force the first clutch plate into contact with the second clutch plate;
an input shaft connected to the first clutch plate; and
an output shaft connected to the second clutch plate,
wherein the automated slip clutch assembly is configured to transfer rotational force applied to the input shaft to the output shaft when a force level applied to the input shaft is below a predetermined slip threshold and wherein when a force level applied to the input shaft is above the predetermined slip threshold, force applied to the input shaft is not transferred to the output shaft.

12. The automated slip clutch assembly of claim 11, wherein the first clutch plate comprises a first surface and the second clutch plate comprises a second surface, the first surface is in contact with the second surface, and wherein the first surface and the second surface are each angled with respect to a plane intersecting the central axis of the automated slip clutch assembly.

13. The automated slip clutch assembly of claim 11, wherein above the predetermined slip threshold, the first clutch plate or the second clutch plate translates axially along a central axis of the automated slip clutch assembly.

14. The automated slip clutch assembly of claim 13, further comprising a microswitch positioned to electrically monitor axial translation of the first clutch plate or the second clutch plate and to send an electrical signal if axial translation is detected.

15. The automated slip clutch assembly of claim 14, wherein:
the input shaft is arranged to rotate in a first rotational direction for extrusion and to rotate in a second rotational direction opposite the first rotational direction for retraction, and
the automated slip clutch assembly has a predetermined slip threshold for extrusion and a predetermined slip threshold for retraction and the predetermined slip threshold for retraction is greater than the predetermined slip threshold for extrusion.

16. A self-contained automated slip clutch assembly comprising:
a first clutch plate;
a second clutch plate;
a spring plate; and
a spring positioned to exert a spring force on the spring plate and the first clutch plate,
wherein the self-contained automated slip clutch assembly is configured to transfer rotational force applied to the first clutch plate to the second clutch plate when a force level applied to the first clutch plate is below a predetermined slip threshold and wherein when a force level applied to the first clutch plate is above the predetermined slip threshold, rotational force applied to the first clutch plate is not transferred to the second clutch plate.

17. The self-contained automated slip clutch assembly of claim 16, wherein below the slip threshold, the spring rotates around a central axis of the self-contained automated slip clutch assembly with the first clutch plate and the second clutch plate.

18. The self-contained automated slip clutch assembly of claim 16, wherein above the slip threshold, the second clutch plate translates axially along a central axis of the self-contained automated slip clutch assembly.

19. The self-contained automated slip clutch assembly of claim 16, wherein the first clutch plate is arranged to rotate in a first rotational direction for extrusion and to rotate in a second rotational direction opposite the first rotational direction for retraction, and the self-contained automated slip clutch assembly has a predetermined slip threshold for extrusion and a predetermined slip threshold for retraction and the predetermined slip threshold for extrusion is unequal to the predetermined slip threshold for retraction.

20. The self-contained automated slip clutch assembly of claim 19, wherein the predetermined slip threshold for retraction is greater than the predetermined slip threshold for extrusion.
